(19) United States
(12) Patent Application Publication
(10) Pub. No.: US 2008/0230446 A1
(43) Pub. Date: Sep. 25, 2008

(54) Method For Treating Dust And Devices For Carrying Out This Method

(75) Inventors: Andre Bertram, Bielefeld (DE); Guenther Ennen, Enger (DE); Joerg Kinnius, Spenge (DE); Stefan Tiekoetter, Bielefeld (DE); Dirk Wegener, Bielefeld (DE); Cornelius Wolf, Bielefeld (DE)

Correspondence Address: DARBY & DARBY P.C., P.O. BOX 770, Church Street Station, New York, NY, 10008-0770, US

(73) Assignee: Miele & Cie KG, Guetersloh (DE)

(21) Appl. No.: 12/064,907

(22) PCT Filed: Aug. 23, 2006
(86) PCT No.: PCT/EP2006/008252

§ 371 Date: Feb. 26, 2008

(30) Foreign Application Priority Data
Aug. 26, 2005 (DE) 10 2005 041 170.3
Oct. 5, 2005 (DE) 10 2005 047 812.3
Dec. 21, 2005 (DE) 10 2005 061 725.5
Dec. 21, 2005 (DE) 10 2005 061 742.5
Feb. 8, 2006 (DE) 10 2006 006 011.3

(51) Int. Cl. B03B 1/04; A47L 9/10

(52) U.S. Cl. 209/10; 15/347

(57) ABSTRACT

A method for treating dust including: separating, in a vacuum cleaner, the dust into at least two fractions which differ in at least one of a size and a mass of particles of the dust; and adding a dust-binding agent to at least a first of the fraction.

### CROSS-REFERENCE TO RELATED APPLICATIONS

This is a U.S. national phase application under 35 U.S.C. § 371 of International Patent Application No. PCT/EP2006/008252, filed Aug. 23, 2006, and claims benefit of German Patent Application No. 10 2005 041 170.3, filed Aug. 26, 2005, German Patent Application No. 10 2005 047 812.3, filed Oct. 5, 2005, German Patent Application No. 10 2005 061 725.5, filed Dec. 21, 2005, German Patent Application No. 10 2005 061 742.5, filed Dec. 21, 2005, German Patent Application No. 10 2006 006 011.3, filed Feb. 8, 2006. The International Application was published in German on Mar. 1, 2007 as WO 2007/022959 A2 under PCT Article 21(2).

### FIELD

The present invention relates to a method for treating dust in a vacuum cleaner. The present invention also relates to various devices for carrying out such a method.

### BACKGROUND

Vacuum cleaners, in particular canister vacuum cleaners, use dust retention systems which are generally disposed between the air inlet of a dust collection chamber and the suction side of a fan and which retain the collected dust before it enters the fan. The best-known variant is a filter which is in the form of a bag and which is internally loaded, i.e., dust accumulates inside the bag. Generally, a fine dust filter is disposed downstream of the bag, said fine dust filter collecting dust particles which have a size of less than 2 μm and which have passed through the bag. As the number of allergic persons increases, it is increasingly important to remove this dust fraction from the ambient air because such particles are respirable because of their small size and, therefore, may have adverse effects on health. When the maximum collection capacity of about 400 grams is reached, the bag needs to be replaced. In the case of sealable bags in particular, this can be done in a hygienic manner, since the dust remains in the bag and is disposed of therewith. Depending on usage, replacement is required several times a year, which generates costs. The fine dust filter also needs to be replaced after a certain period of use, but the intervals are longer here because of the small amount of fine dust. Manufacturers recommend replacement after about one year. Due to the small particle sizes, the mass fraction of fine dust produced is small and, therefore, commercial fine dust filters have a capacity of about 10 grams.

Some mini vacuum cleaners, multipurpose vacuum cleaners, or industrial appliances use externally loaded filters, which enclose the fan. The advantage is the higher collection capacity, while the disadvantage is that the filters of such vacuum cleaners are designed only for coarse dust. The fine dust, which contains allergenic pollens and microorganisms, passes through the filter and is blown back into the room by the fan, and is even stirred up in this process.

There is a desire for a filter system for coarse dust that can be reused and has the following features:

a compact design;

a filter performance comparable to that of a dust bag;

hygienic removal of the collected dust;

low losses in suction power.

The systems known in this connection are primarily the following:
1. washable and reusable textile filter bags (DE 199 11 331 C1). There are concerns with such bags, primarily with regard to hygiene, because the heavily soiled bags must first be manually emptied and then washed in a washing machine.
2. dust cartridges made of porous sintered material (EP 1 179 312 A2);
3. centrifugal separators, called “cyclones” (EP 0 647 114 B1).

The latter two systems allow the dust collection container to be easily removed, emptied, and cleaned if soiled. Conventional systems, in particular cyclone separators, attempt to simulate the dust separation known from dust bags. For this reason, the cut size of the separators is very small. Accordingly, due to the low degree of separation sharpness, the dust collection containers contain large quantities of respirable fine dust. As a result of this, during emptying of such containers, the lighter fractions of the dust being removed fly up and are dispersed in the air. This may have adverse effects, especially on people with allergies.

### SUMMARY

It is therefore an aspect of the present invention to provide a method for treating dust and devices for carrying out such a method, by which disposal is improved from a hygiene point of view.

In an embodiment the present invention provides a method for treating dust. The method includes: separating, in a vacuum cleaner, the dust into at least two fractions which differ in at least one of a size and a mass of the dust particles; and adding a dust-binding agent to at least a first of the fractions.

### BRIEF DESCRIPTION OF THE DRAWINGS

Aspects of the present invention will now be described by way of exemplary embodiments with reference to the following drawings, in which:

FIG. 1 is a schematic view of an exemplary embodiment of a vacuum cleaner according to the present invention;

FIG. 2 is a perspective exploded view of the dust collection chamber of the vacuum cleaner shown in FIG. 1;

FIG. 3 is a top view of the vacuum cleaner of FIG. 1;

FIG. 4 is a cross-sectional side view of a dust collection chamber having a dispensing device;

FIG. 5 is a partially cross-sectional view of another exemplary embodiment of a dust collection chamber having a dispensing device;

FIG. 6 is a partially cross-sectional view of a further exemplary embodiment of a dust collection chamber, which has a heating device;

FIGS. 7a, b are two views of a dust collection chamber according to an alternative embodiment;

FIG. 8 is a schematic view of a separate device for binding dust; and

FIG. 9 is a detailed cross-sectional view showing the device of FIG. 8 with a cartridge;

FIG. 10 is a view of a dust collection container having a pressing device;

FIG. 11 is a view of a dust collection container having an agitator;

FIGS. 12a, b are views of another alternative for binding dust;

FIGS. 13 through 15 are views showing a vacuum cleaner and a dust collection container in which an electromagnetic field is used to bind dust;

FIG. 16 is schematic view of a three-fraction dust separator;

FIG. 17 is a view of a dust collection container having a water inlet;

FIG. 18 is a view showing the dust collection container of FIG. 17 during emptying;

FIG. 19 is a cross section through a dust separation container 1 designed in accordance with the present invention;

FIG. 20 is a top view of dust separation container 1 of FIG. 1;

FIGS. 21, 22 are views of further embodiments of dust separation containers 1 designed in accordance with the present invention;

FIGS. 23, 24 are views of an exemplary embodiment of a dust separation container designed in accordance with the present invention, in which dust is separated into three fractions;

FIGS. 25, 26 are views illustrating the basic design of a fine dust filter according to the present invention;

FIGS. 27, 28 are detailed top and side views of a first embodiment of the fine dust filter; and

FIG. 29 is a top view of a second embodiment of the fine dust filter.

### DETAILED DESCRIPTION

In accordance with an exemplary embodiment of the present invention, dust is separated into at least two fractions which differ in the size or mass of the dust particles, and a dust-binding agent is added to a fraction, so that the dust is not just loosely deposited in a dust collection chamber, but is bound and interlinked to a certain extent, and that no swirling occurs when emptying the dust collection chamber. In this manner, exposure to fine dust, pathogenic particles, or other harmful substances is reduced, and the handling of the dust collection chamber, which needs to be emptied at regular intervals, is made significantly more hygienic. Moreover, the contents of the dust collection chamber can be disposed of at once as a mixture, for example, as a lump.

The fraction of the dust particles which for the most part are smaller than the fraction to which a dust-binding agent is added can then advantageously be collected by a fine dust filter. This prevents particles of this fraction from being returned into the ambient air and being dispersed therein.

In an advantageous embodiment, the dust is separated into three fractions which differ in the size and/or mass of the dust particles, and a dust-binding agent is added to the fraction of the dust particles which for the most part are of medium size or mass. The first fraction contains only coarse particles and can be emptied without stirring up dust and without using any binding agent. Therefore, binding agent is needed only for the middle fraction. The amount required for binding can therefore be significantly reduced compared to methods where the first two fractions are collected in one container.

The devices used for separating the dust should be dimensioned such that the first fraction contains mainly dust particles having a size larger than 200 μm, that the second fraction contains mainly dust particles having a size of between 200 μm and 30 μm, and that a third fraction contains mainly dust particles having a size of less than 30 μm. A portion of the particles of the third fraction have a size of up to 30 μm and are therefore still very large, which results in a requirement for a fine dust filter having a very high collection capacity. However, in this manner, the number of respirable fine dust particles contained in the second fraction is kept very low, even if the sharpness of separation is low. In this manner, hazards which may occur to users when emptying the container of the second fraction are prevented or kept to a minimum, even if they decide not to use a dust-binding agent, or if they forget to add it.

It is also advantageous if the dust-binding agent is added into a dust collection container that can be inserted into the vacuum cleaner and removed therefrom. On the one hand, this allows for easy removal of the conglomerate of dust and dust-binding agent without requiring additional containers and, on the other hand, enables easy cleaning of the dust collection container.

With regard to other suitable or even advantageous embodiments of the method according to the present invention, reference is made to the further dependent claims 6 through 19.

A device according to an exemplary embodiment of the present invention for carrying out the above-described method has an arrangement by which dust picked up by a vacuum cleaner is separated into at least two fractions which differ in the size of the dust particles, the device further having an arrangement configured to add a dust-binding agent into the fraction contained in a dust collection container, and a fine dust filter for collecting the fraction of the dust particles which for the most part are smaller than those of the fraction to which a dust-binding agent is added.

One suitable device for separating the dust operates according to the principle of inertia. It is used in a vacuum cleaner including an air inlet, an air outlet, and a rigid-walled collection container. The air inlet and the air outlet are separated from the collection container by a partition having an opening. Moreover, the air inlet, air outlet, and the partition and its opening are arranged so as to cause an abrupt change in direction of the air flow in such manner that dust particles of a predetermined minimum size are separated from the air flow and retained in the collection container below the partition. A device of this kind can be used to advantage in conjunction with a dust-binding agent, but can also be used in vacuum cleaners whose collection containers are emptied conventionally without adding a dust-binding agent.

A separator device of this kind has the advantage of separating coarse and fine dust inside the container, which allows for hygienic emptying. The collection container can be emptied without stirring up dust, because only small amounts of fine dust are contained in this container. The fine dust can advantageously be neutralized by the dust-binding agent.

To this end, it is advantageous if the outlet openings and the fine dust filter extend in the upper covering surface and in the side walls adjacent thereto. Another advantage ensues from the compact design, which allows for adaptation to the inner contours of a dust collection chamber of a vacuum cleaner, in particular of a canister vacuum cleaner.

In accordance with an exemplary embodiment of the present invention, the air inlet of the container is formed in a covering surface of the container, and the partition is disposed such that it approximately parallel to the covering surface, at least in the region of its opening.

In an advantageous embodiment, the opening in the partition is surrounded by a collar directed toward the air inlet. Thus, the space between the upper covering surface and the partition is increased and has sufficient collection capacity for the fine dust. Moreover, the volume flow through the annular gap is smoothed, even if the air inlet opening is disposed asymmetrically within the fine dust filter.

Optimum deflection of the air flow is achieved by the fact that both openings are circular in shape and form a cylindrical or frustoconical gap. The width of the gap should be such that the cylindrical or frustoconical lateral area formed by the gap is approximately equal to the cross-sectional area of the air inlet opening. This prevents turbulences from occurring in the collection chamber.

In a further advantageous embodiment, the partition is provided with a bypass opening. This prevents the coarse dust from being stirred up in the collection container, because the positive pressure resulting from the swirling of air is removed from the collection container.

To facilitate handling during the emptying operation, the collection container is removable from the remainder of the container. The dust separation container is of an advantageous construction because it includes, in addition to the collection container, a cover and the partition; the cover including the air inlet, openings for air outlet, and a fine dust filter. Thus, the partition and the cover can be formed separately, which, on the one hand, facilitates production and, on the other hand, allows for easy removal of the fine dust filter for cleaning.

An advantageous dust separation container has at least two collection containers for collecting dust fractions of particles of different sizes or masses, said containers being fluidically arranged in series. These containers should be designed such that the cut size of the first container is about 200 μm and the cut size of the second container is about 30 μm. The first fraction, which contains only coarse particles, can be emptied without stirring up dust and without using any binding agent. Therefore, binding agent is needed only for the middle fraction. The amount required for binding can therefore be significantly reduced compared to methods where the first two fractions are collected in one container. Moreover, a dust separation container of this kind can also be used without using a dust-binding agent, especially by people who are not allergic, because the second fraction contains only a very small amount of respirable fine dust particles, even if the sharpness of separation is low. In this manner, hazards which may occur to users when emptying the container of the second fraction are prevented or kept to a minimum, even if they decide not to use a dust-binding agent, or if they forget to add it.

A device according to an exemplary embodiment of the present invention for adding a dust-binding agent into the dust collection container can be disposed as externally, separately from the vacuum cleaner, internally in the vacuum cleaner, or in a vacuum attachment of the vacuum cleaner.

A suitable fine dust filter should have a collection capacity of at least 200 grams. Since, because of the cut size of 30 μm, particles of relatively large size and mass reach the fine dust filter, a commercial fine dust filter having a collection capacity of about 10 grams would be quickly saturated. This would contradict the idea of a vacuum cleaner that is designed to use no, or only a small amount of, consumables. For this reason, a filter capacity is selected that guarantees a service life of over one year given normal use. In addition to the increased service life, a further advantage obtained is that the flow loss is only about 20 percent (at the end of the service life, relative to the initial condition). A filter of this kind is preferably used in a vacuum cleaner that uses a dust-binding agent for the next larger fraction. However, such a filter can also be used without a dust-binding agent, especially if the cut points of the dust separation container are so sharp that the next larger fraction does not contain any respirable particles.

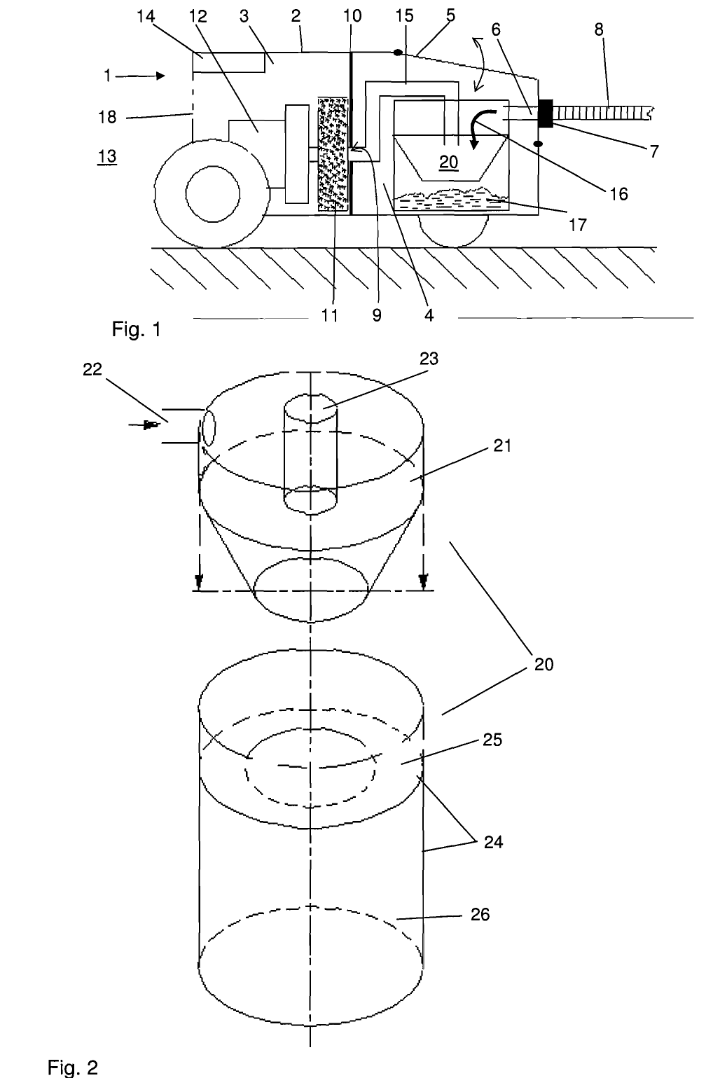

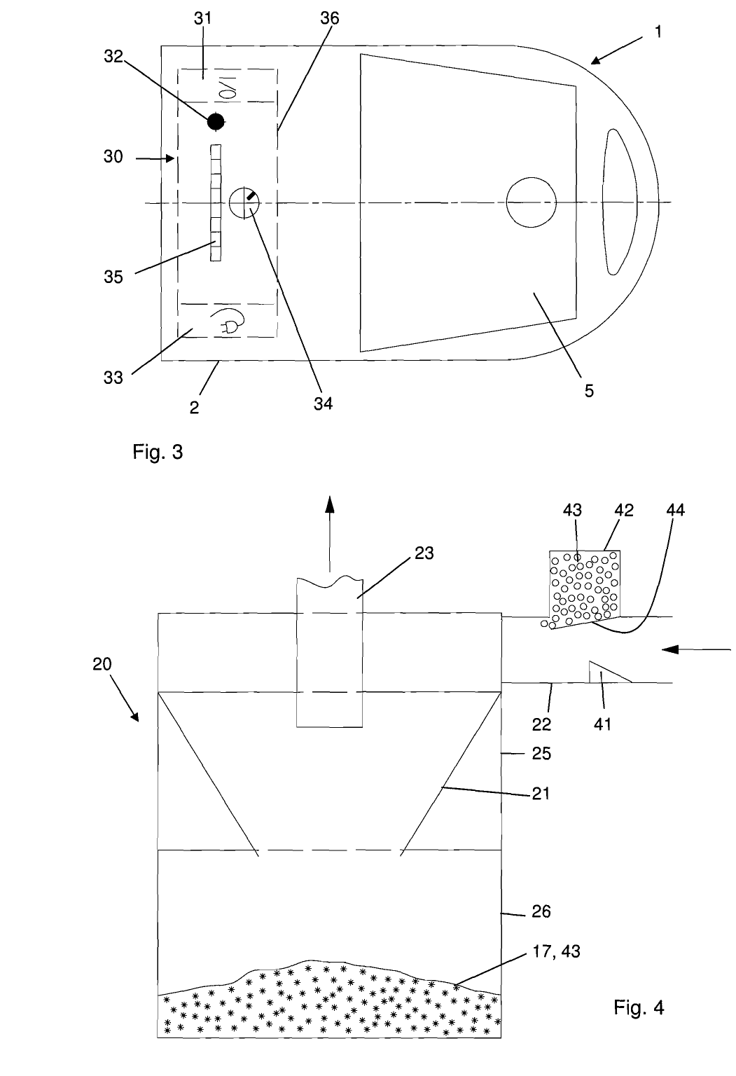

FIG. 1 is a purely schematic view in longitudinal section of a vacuum cleaner 1. Vacuum cleaner 1, as usual, includes a housing 2, which is divided into a fan chamber 3 and a dust collection chamber 4. Dust collection chamber 4 is closed by a hinged cover 5 and has a first opening 6 at which the coupling 7 of a suction hose 8 ends. Various vacuum attachments can be attached to suction hose 8, possibly via a suction wand interposed therebetween. A second opening 9 is provided in partition 10 between dust collection chamber 4 and fan chamber 3. A fine dust filter 11 is located behind this opening 9. A motor fan 12 is mounted in fan chamber 3 behind the fine dust filter. The suction side of the fan faces fine dust filter 11 and opening 9, while its discharge side is in communication with ambient air 13 via further openings 18, which may have a filter (not shown) placed upstream thereof. Located above the fan chamber is a compartment 14 for receiving an appliance controller, and controls and indicators (see FIG. 3). When fan 12 is turned on, dust-laden air (symbolized in the figure by arrow 16) is passed in known manner through suction hose 8 and through dust collection chamber 4, in which a bagless dust collection system is placed to separate coarse dust 17 therein. In the exemplary embodiment shown, said system is a cyclone separator 20, but it is also conceivable to use the variants mentioned at the outset, namely an inertial separator or a dust cartridge. The separator used is tailored such that a fraction of particles which for the most part are larger than 30 μm is collected within the dust collection chamber.

FIG. 2 is a detail view of cyclone separator 20. The cyclone separator includes a cyclone cone 21 provided with an air inlet 22 and an air outlet 23. Air inlet 22 is in fluid communication with opening 6, while air outlet 23 is in fluid communication with opening 9 via conduit 15 (see FIG. 1). Cyclone cone 21 is inserted into a cylindrical container 24 which, as shown in the figure, may be divided into a tubular holder 25 and a dust collection container 26 located therebelow. The dust-laden air drawn in is set into rotary motion in cyclone cone 21 so that, according to the centrifugal principle, coarse dust 17 is thrown against the outer wall, whereupon it falls down into dust collection container 26. The fine dust is separated by fine dust filter 11 in the downstream path of the air. When container 26 is full, which can be detected by filling-level, pressure, or dust-quantity sensors, or simply by measuring the ON-times of the fan, the user is informed of this condition via an indicating device 35 (see FIG. 3).

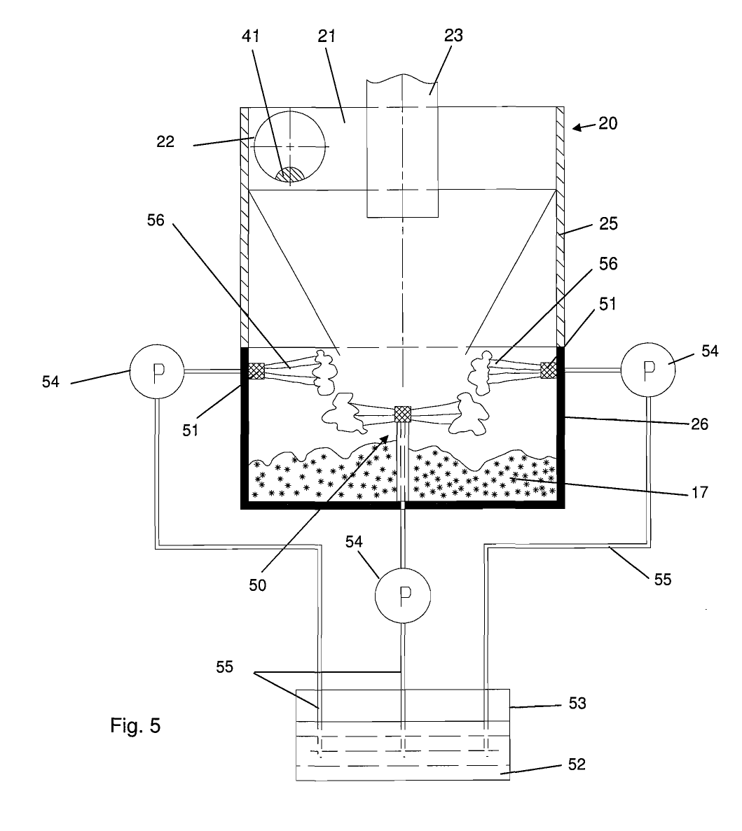

FIG. 3 is a top view of a vacuum cleaner 1 designed in accordance with the present invention. A control panel 30 includes the known controls and indicators, such as an ON/OFF switch 31, a replacement indicator 32 for fine dust filter 11, a cord winder button 33 and a power controller 34, and, in addition, is provided with further elements, whose function will be explained later. These further elements may include the above-described indicator 35 for emptying of dust collection container 26. In the following exemplary embodiments (FIGS. 4 and 5), the replacement indicator is activated by a piezoelectric sensor known from EP 0 759 157 B1, which provides to the appliance controller (symbolized in the figure by dashed-line box 36) a signal that correlates with the quantity of dust that has been picked up. The user can then separate dust collection container 26 from the remainder of cyclone separator 20 and remove coarse dust 17. This is where the present invention comes in:

In order to prevent the coarse dust from being stirred up during emptying of the dust collection container, a dust-binding agent is added thereto. A dust-binding agent in accordance with the present invention is a single- or multi-component additive which is present in the solid and/or liquid and/or gaseous phase, the phase possibly being able to be changed in order to permeate and mix the loose, unbound dust that has been drawn in, and to bind the dust, at least partially. The dust-binding agent is intended to bind fine dust, germs, bacteria, pollens, and other harmful substances present in the dust collection container, in addition to the coarse dust, to prevent them from being stirred up and causing adverse effects to the user during disposal. Thus, the filled dust collection chamber can be emptied in an hygienic manner and without stirring up dust. Dust-binding agents that can be used include suitable dispersible liquids, powder, foam, granular material, or solid substances, especially in pelletized form. Moreover, it is possible to add scents, cleaning or anti-germ substances to the dust-binding agent. The dust-binding agent is added into the dust collection container by a suitable device, which may either be incorporated within the vacuum cleaner or be integrated into a vacuum attachment, or it may be constructed as an external device having a receptacle for the dust collection container.

FIGS. 4 and 5 show exemplary embodiments of dust collection containers into which a dust-binding agent is added and mixed with the dust. The dust-binding agent may be a liquid, powder, foam, or granular material, or mixtures thereof. In particular when using granular material, a substance which improves the adhesion of dust should be added thereto. Moreover, the dust-binding agent can be supplemented with agents having cleaning activity, such as by adding surfactants or other substances that promote cleaning action. It is also possible to add bacteriocidal, bacteriostatic and/or fungicidal agents in order to prevent germs from growing inside the dust collection container. Such properties can be obtained, for example, by doping the material with silver ions. Furthermore, it is possible to use scents to make the handling of the dust collection chamber more pleasant.

In order for the dust-binding agent to perform its function in accordance with the present invention, it must be brought into contact with the dust. The dispensing of dust-binding agent can be done in the following ways:
The dust-binding agent is dispensed directly into the dust collection container by the user. This option is extremely cost-effective, because there is no need for any active elements to be installed in the vacuum cleaner, but has the disadvantage that the user may come into contact with the collected dust before it is bound. In order to overcome this disadvantage, the dust-binding agent can be drawn in by turning on the fan.
The dust-binding agent is dispensed into the dust collection container by a dispensing device. Activation is via actuating device provided on the vacuum cleaner, on the vacuum attachment, or on the external device.
The dust-binding agent is automatically dispensed by the vacuum cleaner or by the vacuum attachment. This may be done while the fan is ON by suitable dispensing devices in the region of the air inlet, or directly into the dust collection container.
The dust-binding agent is dispensed at the beginning of a vacuuming process; the quantity required for the dust collection container being added either at once after the emptying process or in several steps. Moreover, the dust-binding agent can also be added after the vacuuming process. With respect to quantity, time of addition and/or frequency of addition, the activation of the dispensing device required for this purpose can be controlled as a function of time, filling level or dust quantity. This can be done using the same devices as those used for the replacement indicator described at the outset.
The dust-binding agent is added automatically when inserting the dust collection container.

It is advantageous to use a mixing arrangement to mix the dust with the dust-binding agent, especially if the agent is added at the beginning or end of the vacuuming process, or if it is added in an external device. To this end, it is possible to use mechanical or motive device which set the container into motion, rotation, or vibration.

In the exemplary embodiment shown in FIG. 4, air inlet 22 has disposed therein a dust-quantity sensor 41 which measures the quantity of dust passing therethrough. Air inlet 22 further has provided therein a dispensing device 42 for a dust-binding agent 43 in the form of powder and/or granular material. The quantity measured by dust-quantity sensor 41 is transmitted to appliance controller 36. If the detected quantity indicates that collection container 26 must be emptied, said appliance controller causes the dust-binding agent to be dispensed via a dispensing flap 44 into air inlet 22 and to be dispersed in the still dust-laden air therein. By subsequently swirling the air, dust 17 and dust-binding agent 43 together, an optimum mixing is achieved. Dust-binding agent 43 and dust 17 are collected together in container 26, and can then be disposed of at regular intervals. The dispensing of dust-binding agent 43 can be done via flaps, pistons, screws and/or nozzles. The addition of the dust-binding agent can be done either directly in collection container or dust collection chamber 26 or in the region of air inlet 22; it being possible for the addition to take place, for example, already at the vacuum attachment of vacuum cleaner 1 (not shown).

FIG. 5 shows another embodiment of a dust collection container 26, in which coarse dust 17 is bound. To this end, at least one spray device 50 is provided on container 26, said at least one spray device being usable to dispense a fluid 52 into dust collection chamber 26. Spray device 50 includes a reservoir 53 in which fluid 52 is contained as a dust-binding agent. Also provided are dispensing pumps 54 which can be activated by appliance controller 36 and which are used to convey liquid dust-binding agent 52 into dust collection container 26 through hoses 55. To this end, there are provided one or more nozzles 51 from which the fluid 52 conveyed through hoses 55 is dispensed into dust collection chamber 26 and atomized. The dispersed, dust-binding fluid 52 is symbolized by the spray 56. Dust-binding agent 52 may be a glycol- or glycerol-containing liquid which reduces the surface tension to values of less than 40 mN/m and to which may be added fungicidal, bacteriostatic and/or bacteriocidal components. It is also conceivable to use a highly diluted adhesive, such as wallpaper paste. However, liquid dust-binding agent 52 should preferably be dispersible. If the dispensing pumps and nozzles are suitably designed, powdery, foamy, or granular media may be sprayed in place of a fluid. It is also possible to use, in place of pumps 54, other pressure-generating elements for dispensing purposes. Furthermore, dust-binding agent 52 can also be added via controllable valves and dispersed by ultrasound. Here, too, the supplying of liquid dust-binding agent 52 can be controlled as a function of the data provided by a dust-quantity sensor 41 but, alternatively, may also be controlled using one of the alternatives enumerated above. For economic production, the walls of dust collection chamber 26 can be made from plastic. Of course, it is also possible to provide a non-stick coating to facilitate cleaning.

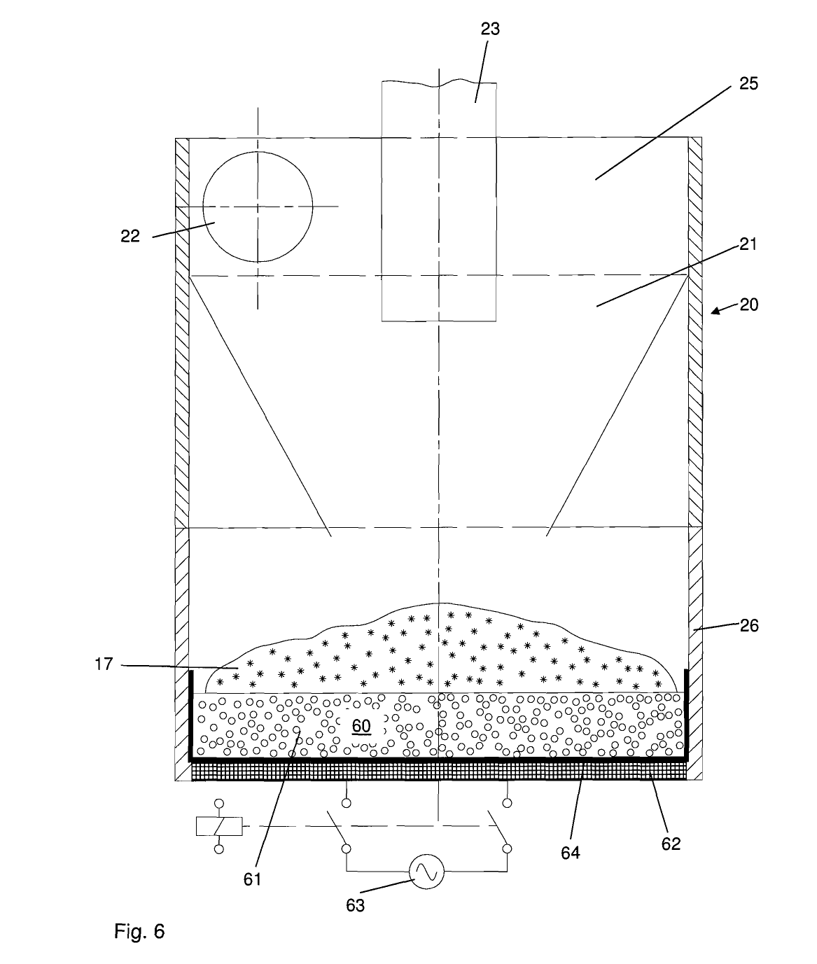

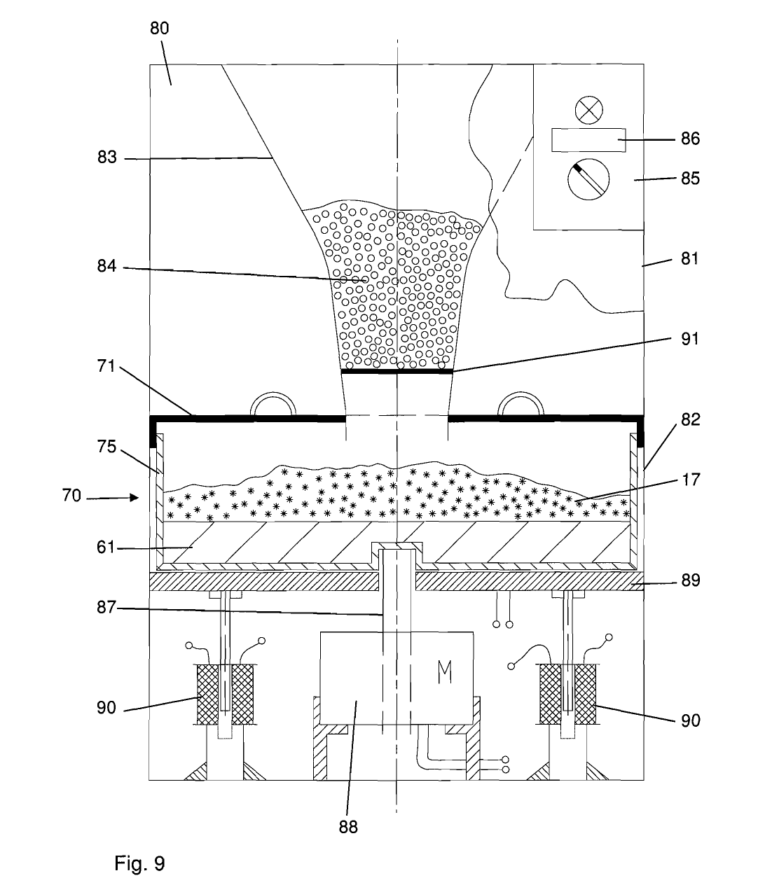

FIG. 6 shows an exemplary embodiment of a dust collection chamber 26 in which dust 17 is bound by a substance which is first melted, then takes up dust 17 and subsequently cools, after which it can be removed from dust collection chamber 26. For this purpose, paraffin 60 may be used and added to the container as a pellet 61 or granular material 84 (see FIG. 9). Container 26 is provided with a heat source 62 which is supplied with electrical power by a power supply 63.

As can further be seen in FIG. 6, a support 64 for paraffin pellet 61 is provided on the bottom of container 26. Also schematically shown is the dust 17 lying on paraffin pellet 61. Container 26 may be removed from vacuum cleaner 1 and cleaned at regular intervals.

During vacuuming, the house dust is first fractionated by cyclone separator 20, during which process particles having a diameter <30 μm pass through cyclone separator 20 and are bound in fine dust filter 11. All other dust particles 17 fall onto paraffin 60 because of gravity. When a certain filling level is reached, the heat source, which is in the form of a heating plate 62, is supplied with electrical power by power supply 63, whereby paraffin 60 is transferred from the solid to the liquid phase. It is also possible to use the heat generated by fan 12.

The density of paraffin 60 is on the order of <1 g/cm³, approximately in the range between 0.5 and 0.7 cm³. According to the Archimedes principle, all bodies having a density >about 0.8 g/cm³ will sink into paraffin 60. This condition is satisfied by house dust particles 17 having a density in the range >1 g/cm³. Due to the density ratio between the individual substances, and because it is relatively easy to produce a phase change of paraffin pellet 61, the dust 17 present in container 26 can be easily bound and caused to sink into paraffin 60. When the filling level of container 26 reaches a sufficient height, the cooled lump of paraffin 60 and bound dust 17 can be disposed of without stirring up dust. It is especially because of the non-polar molecular structure and the low surface tension of paraffin 60, that, other than in the case of water, particles can generally sink very easily into paraffin 60 when the paraffin in the liquid phase. Furthermore, the melting point of paraffin 60 can be adjusted in a wide range.

In order to allow for easy removal of the solidified paraffin 60 from dust collection container 26, paraffin pellet 61 is located in the region of support 64, which is made of a repulsive (non-stick) material, or a material having a repulsive surface, preferably silicone. The support can also be made of Teflon-coated aluminum because of the superior thermal conductivity thereof. Support 64 can be detachably received in container 26 to allow it to be removed and replaced with a new paraffin pellet 61, possibly with a new support.

In addition to substances which can be caused to change their phase by supplying heat energy, it is also possible to use as the dust-binding agent so-called thixotropic substances, whose viscosity can be changed by kinetic energy. Examples of such substances are cellulosic suspensions.

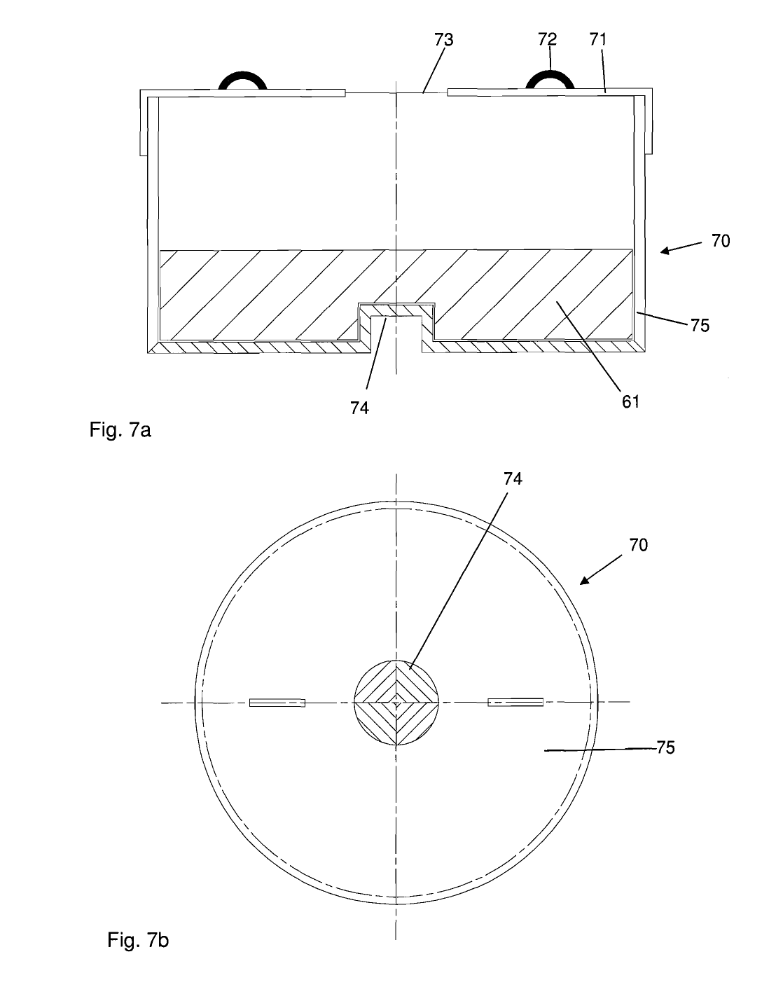

FIGS. 7a and 7b show a dust collection container in the form of a removable cartridge 70, which forms part of the dust collection chamber 4 of a vacuum cleaner 1, as is shown, for example, in FIG. 1. Unlike the preceding exemplary embodiment, cartridge 70 is formed by a cup-shaped container 75 which can be closed by a cover 71. Cover 71 is provided with handles 72 and a central closure member 73. Again, a paraffin pellet 61 is provided as a dust-binding agent in cartridge 70. The bottom of cup-shaped container 75 can also be made of a repulsive (non-stick) layer, such as Teflon or coated aluminum. To ensure that the melting heat is efficiently transferred to paraffin pellet 61, the bottom may be made of metal, such as aluminum. The side wall portion of container 75 can be made of a flexible material, preferably silicone, to allow for easy removal of the paraffin pellet 61. Furthermore, container 75 can be easily cleaned and used multiple times. At the bottom of container 75, there is also provided a socket 74 in which a drive shaft can be engaged.

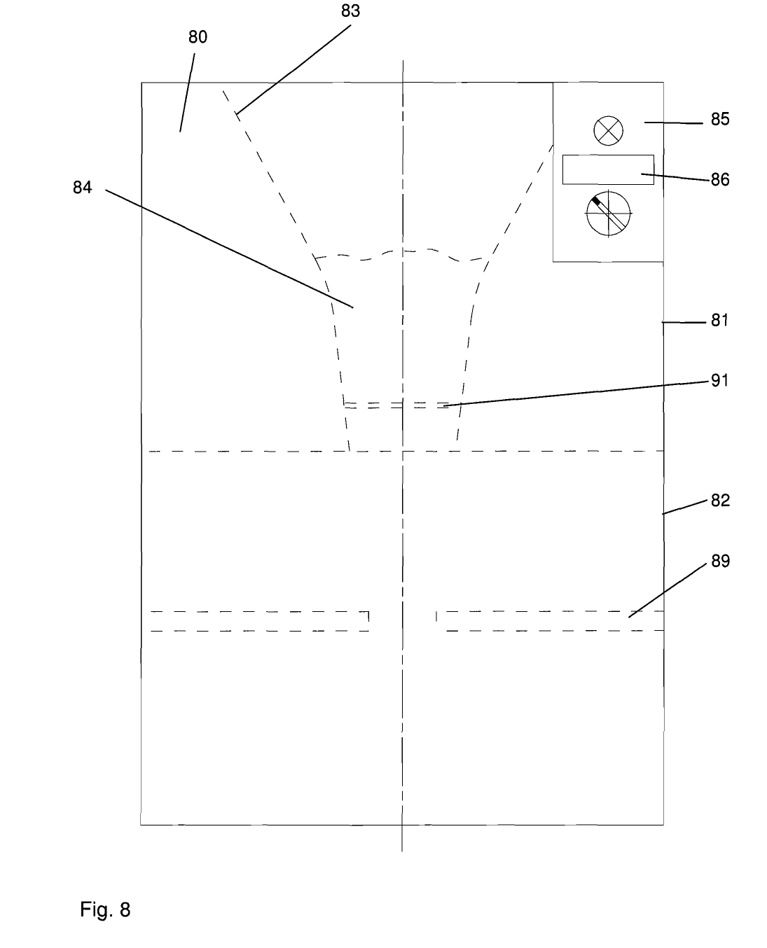

FIGS. 8 and 9 show a separate add-on device 80 for binding the dust 17 contained in cartridge 70. Add-on device 80 essentially includes an upper part 81 and a lower part 82, which are separably and/or movably joined together. Thus, cartridge 70 can be inserted into add-on device 80 after removal of upper part 81. In addition to a feed funnel 83 for a dust-binding agent, such as granular paraffin 84 or paraffin powder, upper part 81 includes a control and display unit 85 having a controller 86. Controller 86, which may be a microcontroller, includes a program which is specifically designed for the binding of dust and has defined steps and parameters, and which can be controlled via control and display unit 85. Furthermore, control and display unit 85 shows the current status of the dust-binding process.

After inserting cartridge 70, dust-binding agent 84 can be added manually or automatically via a gate 91. Thus, granular paraffin 84 serves to seal the mixture of paraffin 60 and dust 17 present in container 75.

Lower part 82 serves to receive cartridge 70, which is placed on a shaft 87 of a drive mechanism 88. Drive mechanism 88 sets cartridge 70 into motion, preferably into rotary motion in continuous and/or pulse mode. The rotation ensures a better mixing of paraffin 60 with dust 17 during the liquid phase due to the action of the centrifugal force.

Moreover, cartridge 70 rests with its bottom on a beat source 89 for melting a paraffin pellet 61. Heat source 89 is also movably mounted, and can be moved in a vertical direction by drive mechanisms 90. Whenever dust container 75 rotates, heat source 89 is lowered. All drive mechanisms 88 and 90, and heat source 89, are activated by controller 86 according to the program. Furthermore, upper part 81 or lower part 82 may have provided therein cooling devices (not shown), such as fans or Peltier elements, in order to accelerate the solidification of paraffin 60.

In order to dispose of dust 17, first, the filled dust cartridge 70 is inserted into add-on device 80. Then, heat source 89 is energized until paraffin pellet 61 has melted. After that, heat source 89 is turned off, and cartridge 70 is lowered onto shaft 87 of drive mechanism 88. Then, cartridge 70 is rotated, whereby dust 17 and molten paraffin are mixed. Moreover, granular paraffin 84 may be added via gate 91. Subsequently, dust cartridge 70 is stopped, and the liquid paraffin 60 is cooled. After that, dust cartridge 70 can be removed, and the mixture contained in cartridge 70 can be disposed of.

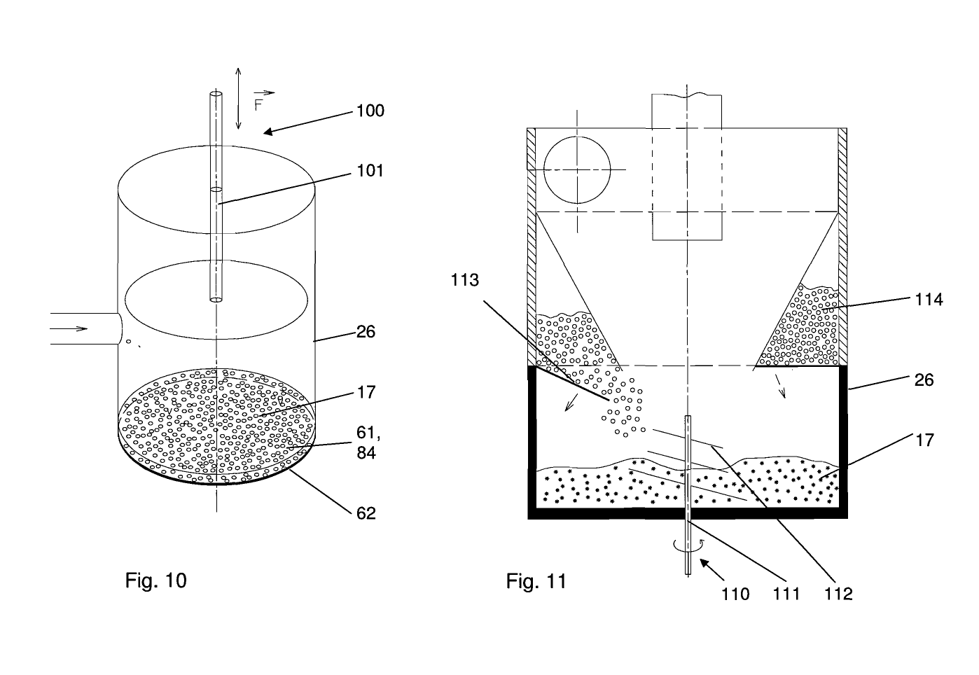

In addition to the described methods of application of the dust-binding agent, preferably paraffin, it is also possible to press the dust into the liquid paraffin so as to minimize the use of dust-binding agent. FIG. 10 shows a dust collection container 26 which is equipped with such a pressing device 100. To this end, removable dust collection container 26 has a compression plunger 101 provided therein which is driven manually or automatically, i.e., by electric motor device or aerodynamically, and is thereby pressed onto coarse dust 17 and the binding agent. After heating plate 62 is energized, the dust is pressed into the liquid binding agent, preferably paraffin 60, whereby a press cake containing dust and binding agent is produced by compaction. The pressing process can be carried out each time the vacuum cleaner is turned off, or when the collection container is completely filled.

It is also possible to mix the dust with the dust-binding agent using an agitator. To this end, an agitator 110, which is driven by a rotating shaft 111, either manually or automatically, is disposed in the dust collection container 26 shown in FIG. 11. Blades 112 of agitator 110 are partially or completely covered by coarse dust 17. A dispensing device 113 containing dust-binding agent 114 is located within or above the dust collection container. Binding agent 114 is dispensed onto coarse dust 17 either continuously (e.g., during operation) or discontinuously (e.g., at each power-on or when the dust collection container is completely filled). Using agitator 110, binding agent 114 is homogenously mixed with dust 17, which makes it possible to minimize the use of binding agent.

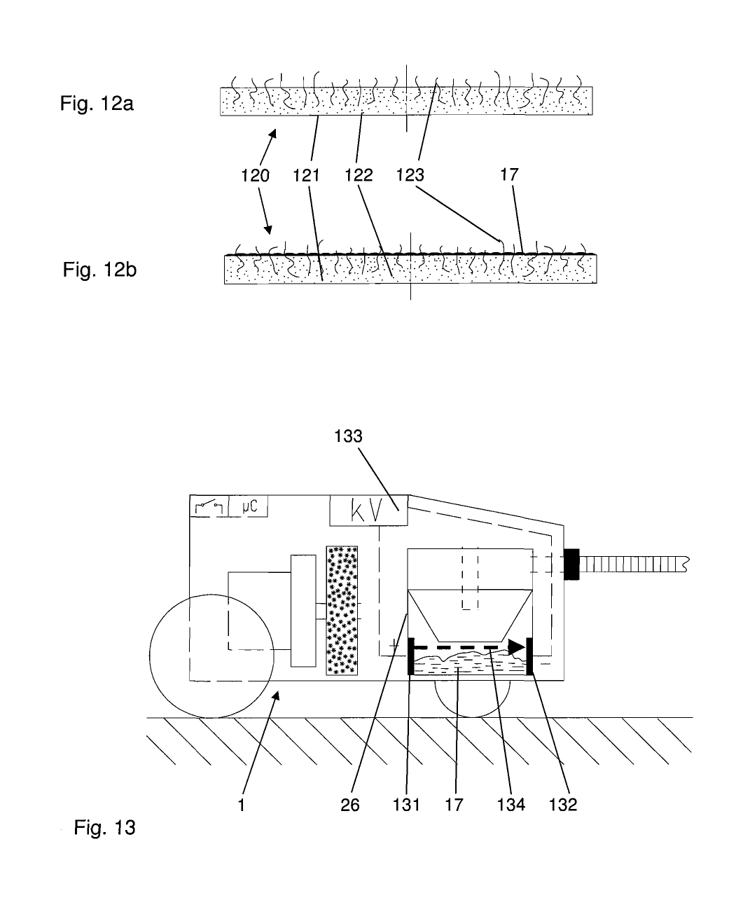

FIGS. 12 and 12b are schematic views illustrating the basic design of another option for binding dust. Here, pads 120 are placed into the dust collection container to completely cover the bottom. Pads 120 are formed by at least two components, a first retention medium 121 including a dust-binding agent 122, and a second retention medium 123 for coarse dust 17. Pads 120 are preferably designed as consumables. The material of the first retention medium is porous to coarse-porous, sponge-like and liquid-retaining, it being preferred to use foamed plastic. The material is impregnated with a liquid dust-binding agent 121. Ideally, dust-binding agent 121 is in the form of a liquid having a low vapor pressure, such as glycerol or glycol. Second dust-retention medium 123 must be permeable to liquid and capable of retaining liquid, have coarse pores, and be fibrous in nature. Preferably, cellulose fibers are used at this location, the fibers being injected into the foamed plastic so as to provide good contact with dust-binding agent 121. Cellulose fibers have a high capillarity, whereby dust-binding agent 121 is transported from the foamed plastic to the surface of second retention medium 123 in order to wet and bind the dust 17 there, and thereby to prevent dust from being stirred up. Thus, a “dust cake” is formed on the surface of retention medium 123 in the course of time, see FIG. 12b. When the capacity of first retention medium 122 is saturated, pad 120 is preferably removed through bottom closure member 124 of dust collection container 26 along with the bound dust 17, without stirring up dust.

FIGS. 13 through 15 are schematic views showing another bagless vacuum cleaner 1 and the dust collection container thereof. At the heart of this embodiment is a device for generating an electromagnetic field which promotes the tendency of coarse dust 17 to agglomerate in dust collection container 26, so as to allow for hygienic removal of the dust without using an additive in the form of a binding material. Real house dust has a tendency to form agglomerates due to its composition (mainly organic constituents). Thus, preferably allergens, such as pollens and mite excrements, bind with larger particles in the house dust. The reasons for this are electrostatic forces due to polarization, and adhesion forces due to a sticky particle surface. By using the device shown and the method described below, the inherent binding forces of the house dust are intensified while preventing stirring up of dust, especially of fine dust and allergens.

FIG. 13 shows the basic design of such device disposed in bagless vacuum cleaner 1 for this purpose. The essential components of the device include two opposite, in particular plate-shaped electrodes 131 and 132, and a high-voltage generator 133. High-voltage generator 133 may be a belt generator aerodynamically driven by the vacuuming air flow of the vacuum cleaner, or an electronic voltage multiplier circuit which derives the high voltage from the mains voltage. Both the high-voltage generator 133 and electrodes 131 and 132 are used to generate a preferably electric field, symbolized by dashed arrow 134. Electrodes 131 and 132 constitute an active capacitor-like system or structure.

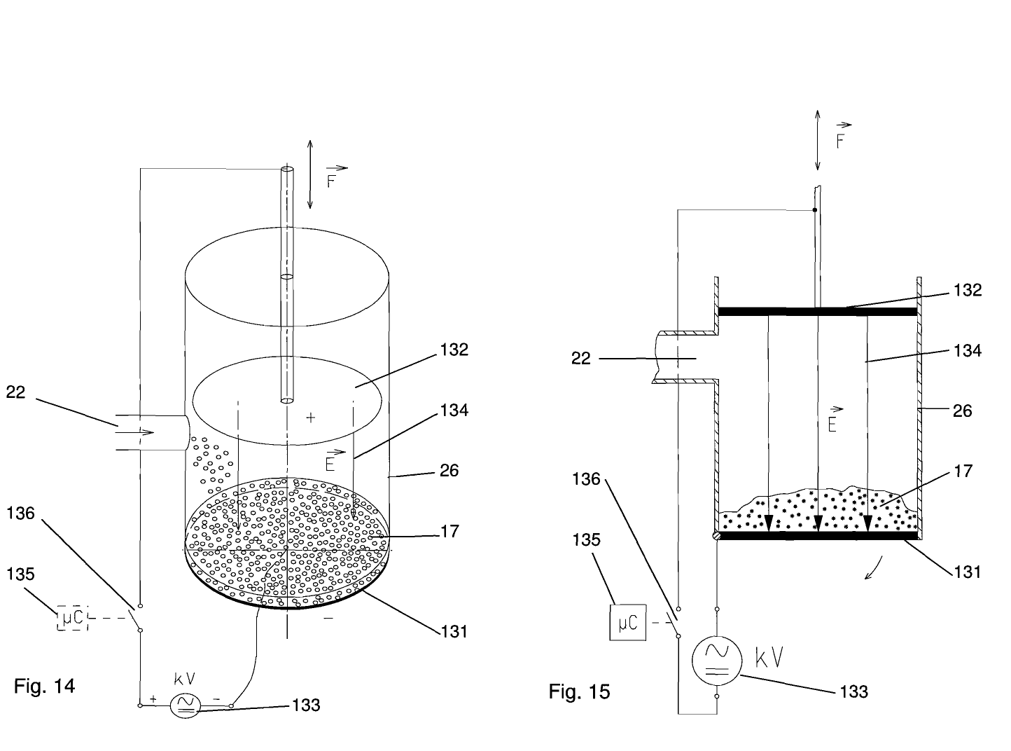

FIG. 14 (perspective view) and FIG. 15 (cross-sectional view) illustrate the design of the device in detail. As is shown in FIG. 14, the dust collection system of the bagless vacuum cleaner is mainly formed by cylindrical dust collection container 26 and air inlet 22. Due to the force of gravity, the coarse dust 17 that has been drawn in settles in the bottom region of dust collection container 26. Inside the dust collection container, there are located the two opposite, contour-adapted electrodes 131 and 132 which form a capacitor, the upper electrode 131 being movable (automatically or manually) so that the distance between the plates can be reduced by the translational movement. Lower electrode 132 is located in the bottom region of dust collection container 26. Thus, dust 17 constitutes the dielectric of the capacitor. Both capacitor electrodes 131 and 132 are connected to high-voltage generator 133 via a switch 136 controlled by microcontroller 135. Electric field 134 forms between the two electrodes 131 and 132. Thus, movable electrode system 131 and 132 constitutes a dust press in the form of a capacitor, the pressing effect being increased by adding electric field 134.

To further illustrate the present invention, FIG. 15 shows a cross-sectional view of the device already described. Preferably, lower electrode 131 is designed such that it can be tilted or pivoted to allow removal of the compressed dust. The high voltage generated by high-voltage generator 133 is preferably a steady-state DC voltage in the range of 1 kV to 3 kV. By compressing the dust with the assistance of the added electrostatic field, polarization effects in the dust are intensified and adhesion forces are used more effectively, so that the binding of dust takes place “by itself”, i.e., without any additive material, and no dust is stirred up during removal. The pressing process assisted by the added electrostatic field is preferably carried out when the dust collection container is full. In another possible alternative, the execution of the pressing process could be controlled as a function of the dust quantity with the aid of a sensor 41 (see FIG. 4). In addition, it is possible to initiate pressing each time the fan is turned on. Moreover, the pressing parameters, such as the pressing time and the level of the high voltage, can be varied according to the signal of dust-quantity sensor 41. The use of a device for pressing dust 17 with the assistance of an added electrostatic field in a bagless vacuum cleaner 1 has the advantages that the dust can be disposed of in a hygienic manner without stirring up dust and without using a bag and/or any other binding agent material and that no fine dust problem occurs during removal.

The device for generating the electromagnetic field can be positioned within, above, or below the dust collection container. Moreover, it can be an active, i.e., generator-type of a device, may be formed of multiple parts, or be designed as a capacitor. The field can be constant or variable, stationary or transient in space or time. There are at least two electrodes, one of which may form the bottom of the dust collection container. The electrodes may be plate-shaped, contour-adapted, or round, disposed opposite each other, linearly movable, and one electrode may be pivotable. The electrode spacing may be variable, for example, by motor device or manually. The generator used for operating the device may operate triboelectrically (example: an aerodynamically driven belt generator) or electronically (example: a voltage multiplier circuit); the high-voltage signal may be a DC or AC signal of high frequency. The activation of the generator and the pressing may take place once (when the container is full), repeatedly (after each power-on), continuously, discontinuously, or may be controlled as a function of the dust quantity. One electrode can swing out of the way during removal.

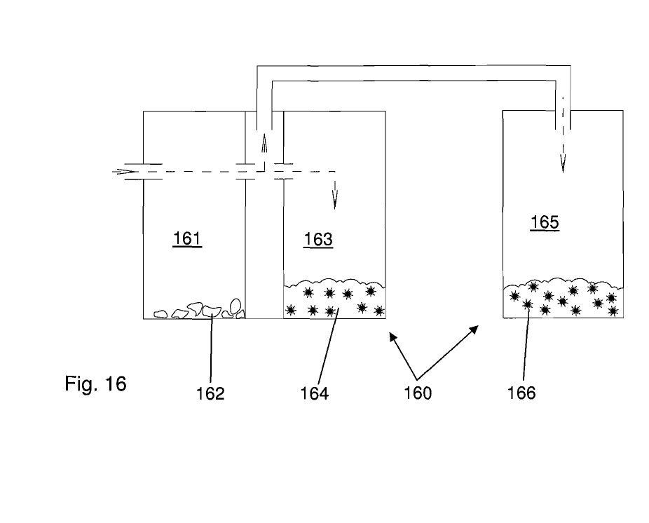

In another variant, water is used as the dust-binding agent. FIG. 16 schematically shows a three-fraction dust separator 160 including a coarse dust container 161 containing coarse dust (first fraction 162), a container 163 for the second (medium) dust fraction 164, and a find dust filter 165 containing fine dust (third fraction 166). The construction of the overall separator is described elsewhere herein.

The dust entering dust separator 160 is divided as follows:

Coarse dust 162 for the most part contains particles having a size greater than about 200 μm. These particles are collected in coarse dust container 161. Particles which for the most part have a size in the range from about 30 μm to about 200 μm are collected in dust collection container 163, while particles smaller than 30 μm for the most part enter fine dust filter 165. In these considerations, it must be kept in mind that the cut points are not sharp. Therefore, second fraction 164 also contains fine dust 166, which is known to have a tendency to be stirred up during removal. Therefore, the dust collection container 163 used for second dust fraction 164 is a container which, together with the application of water 170, allows for hygienic removal of the dust.

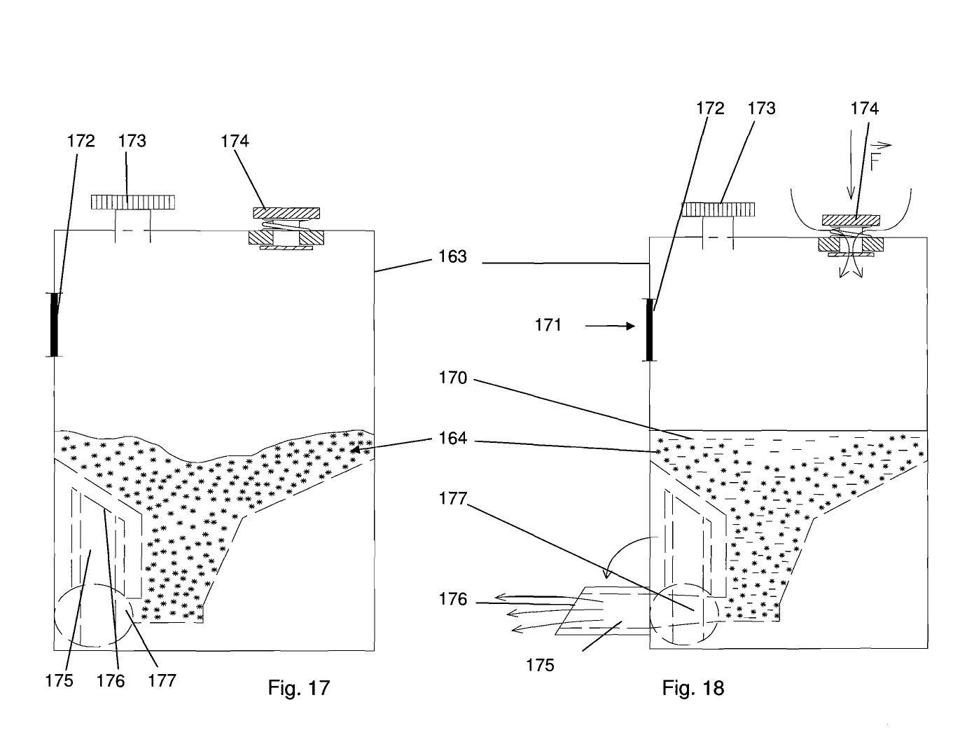

FIG. 17 is a view showing the construction of a suitable dust collection container 163 along with dust 164, a dust inlet 171 having a flap valve 172, a water fill valve 173, a bleed valve 174, a chute 175, an outlet opening 176, and a chute inlet 177. Water 170 is excellently suited for binding dust. Using the water filled in through water fill valve 173, dust 164 in dust container 163 is mixed, possibly by agitating container 163. In the position shown in FIG. 17, chute 175, and its outlet opening 176, is closed, and bleed valve 174 is not actuated, i.e., closed.

FIG. 18 shows dust collection container 163 during emptying. After water 170 and dust 164 are thoroughly mixed, a water/dust mixture is produced, which can be discharged through outlet opening 176 and funnel-shaped chute inlet 177 by pivoting the chute 175. The amount of water added is such that a free-flowing mixture is produced. For purposes of emptying, bleed valve 174 must be opened. Advantageously, the inner walls of dust collection container 163 and all other component parts are treated or coated with a non-stick coating (lotus effect). To be able to empty containers 161 and 163 separately, they are separable from each other. In order to prevent confusions, it is it is advisable that the embodiments have different visual characteristics, in particular different colors. Using water 170 as the dust-binding agent has the advantage that dust 164 can be disposed of in a hygienic manner without stirring up dust and without using a special binding agent material, which eliminates the need for cost-intensive consumables.

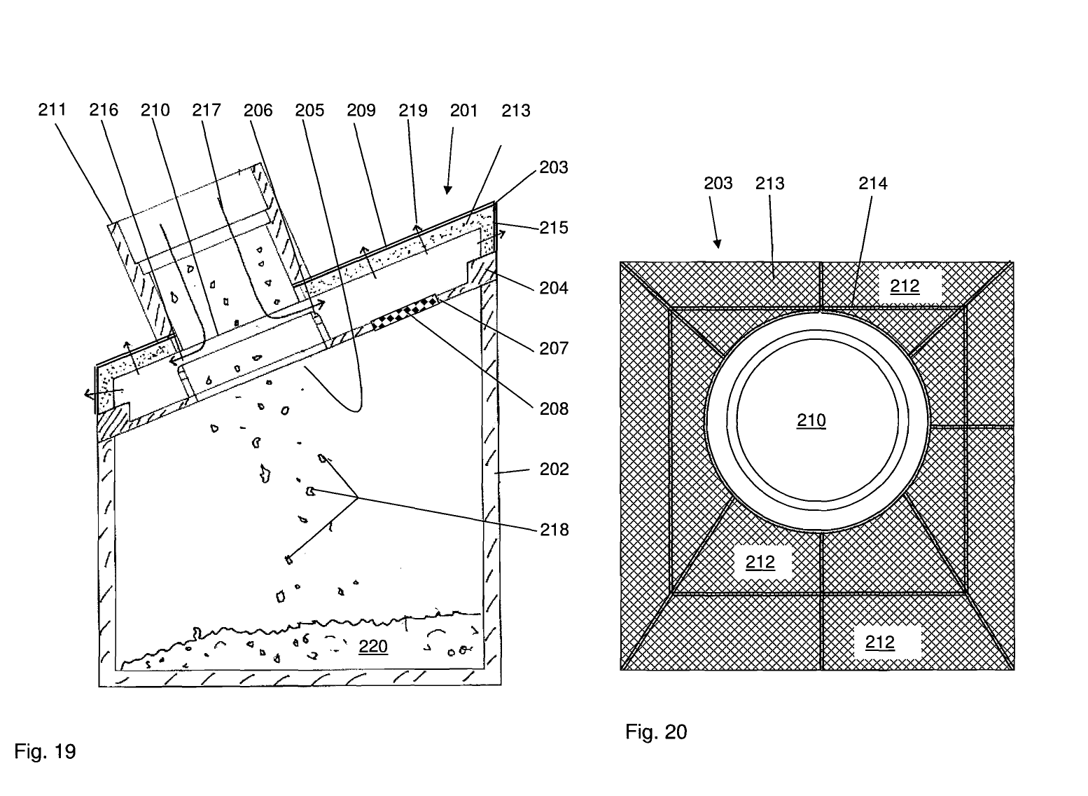

FIGS. 19 through 24 show dust separation containers where the separation of dust occurs according to the principle of inertia. The dust separation container shown in FIG. 19 and denoted by reference numeral 201 is essentially formed by three parts: a collection container 202, a cover 203, and a partition 204 disposed therebetween. All three parts are joined together as a push-fit system, and can be separated for cleaning.

Collection container 202 is formed by a rigid-walled, air-tight plastic part, and its contours are adapted to the dust collection chamber of a canister vacuum cleaner. It can be angular or round in cross-section. Collection container 202 is closed upwardly by partition 204. Partition 204 is provided with a first opening 205 which is surrounded by a collar 206 extending around opening 205 on the side opposite the collection container 202. In addition, a second opening 207 is provided in which is inserted a coarse dust filter 208. Cover 203 is placed on partition 204, the upper covering surface 209 of said cover being oriented at least nearly parallel to partition 204. Cover 203 is provided with an opening 210 which constitutes the air inlet and is surrounded by an air intake collar 221 for this purpose. The air outlet is formed by outlet openings 212 which are provided in cover 203 (see FIG. 20), which should have as large an area as possible, and which are arranged around air inlet opening 210 and covered by an inner fine dust filter 213. To this end, cover 203 is provided with a suitable lattice structure 214, which is shown in FIG. 20. To obtain as large an effective area as possible, both the outlet openings 212 and fine dust filter 213 extend in upper covering surface 209 and in the side walls 215 adjacent of cover 203 adjacent to the upper covering surface.

Air inlet opening 210 and first opening 205 in partition 24 are located coaxially behind each other, and thus, collar 206 forms a surrounding, frustoconical gap 216 whose area is approximately equal to the cross-sectional area of air inlet opening 210. Because the air outlet is arranged around air inlet opening 210, the dust-laden air drawn in is caused to undergo an abrupt change in direction, which is symbolized by arrows 217 in FIG. 19. Due to their inertia, large, i.e., relatively heavy dust particles 218 are unable to follow this change in direction, but maintain their direction of flow and fall into collection container 202. The air, which is freed of coarse dust and is only laden with fine dust at this point of time, is then passed through fine dust filter 213 (see arrows 219), where the fine dust is removed therefrom. In this manner, the movement of air in collection container 202 is minimized, and dirt 220, once it has settled, is not stirred up, unlike in known tank vacuum cleaners, in which the vacuuming air flow is entirely passed through the collection chamber. In the region of the sharp change in direction, turbulences and swirls are inevitably generated and, in a weaker form, may propagate into the collection container. Due to the highly symmetrical design of annular gap 216, these effects are significantly reduced, and a further reduction is obtained by diverting the flow through second opening 207 in partition 204, which acts as a bypass. The filter 208 provided in the opening prevents fine dust filter 213 from being loaded with coarse dust, and must be dimensioned such that it can retain the coarse dust in collection container 202.

In exemplary embodiments of the present invention, it is advantageous to use the following design principles:
1. The area of annular gap 216 is approximately equal to the cross-sectional area of air inlet opening 210. Changing the cross-sectional area would result in an acceleration or a reduction of the air velocity, which would increase the turbulences in the deflection region.
2. The diameter of opening 205 is 10-20% larger than the diameter of air inlet opening 210. This ensures that all coarse dust particles 218 are reliably collected by collection container 202.
3. The height of collar 206 is preferably between 10 and 30 mm. If the distance is too short, disturbances propagate from the deflection region into collection container 202, and produce increased air velocities therein. If the distance is too large, the coarser dust particles 218 no longer reliably reach collection container 202.

The aforementioned design features are targeted to provide a cut size of about 30 μm, which means that only coarser dust 218 will be collected in collection container 202. Thus, stirring up of dust, which is known from conventional cyclone separators, is prevented during emptying of container 202. However, after the separation is effected by deflecting the air, the air still contains an amount of dust so large that conventional blow-out filters disposed downstream of the fan would be completely overloaded unless additional measures were taken.

In accordance with an exemplary embodiment of the present invention, this problem is solved by adding the fine dust filter 213 downstream. Advantageously, this filter is designed such that, in conjunction with the dust separation at annular gap 216, it reaches the filter performance of a conventional dust bag. Filter 213 may be designed as a depth or volume filter, or as a surface filter and, more specifically, as a recoverable permanent filter or as a replaceable, disposable filter.

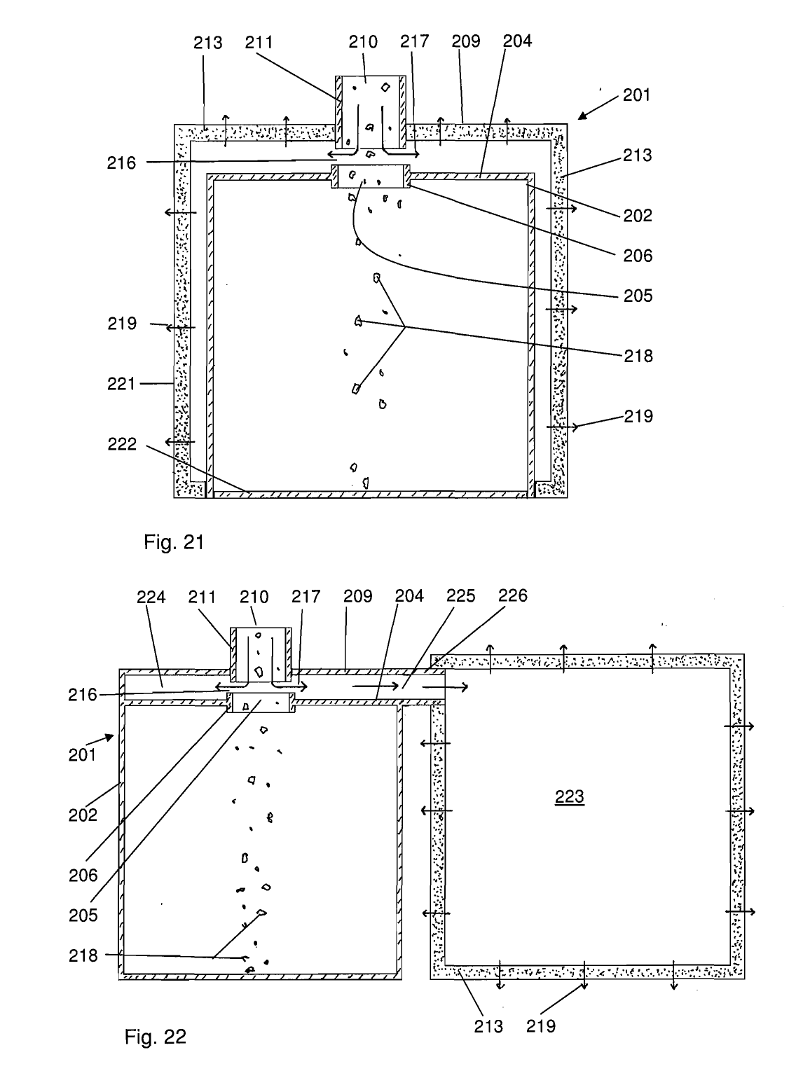

FIGS. 21 and 22 show two further advantageous embodiments of the present invention. Like or functionally equivalent components are denoted by the same reference numerals as in FIG. 19.

The dust separation container 201 shown in FIG. 21 is compact in design, but its fine dust filter 213 is significantly larger than in the first embodiment, because here, in addition to upper covering surface 209, side surfaces 221 are also designed as a filter. In this manner, the collection capacity, and thus the service life of fine dust filter 213, is significantly increased, so that replacement or back-cleaning is required only very rarely (about once a year). Rigid-walled collection container 202 can be easily emptied if its bottom 222 is removable.

Although the major part of the fine dust is bound within filter 213, a small part will soil the surface of fine dust filter 213 and the opposite outer surface of collection container 202. Therefore, in the two embodiments illustrated hereinabove, there is risk of the user coming into contact with the fine dust when removing fine dust filter 213 for purposes of cleaning or replacement.

This disadvantage is obviated by a dust separation container 201 designed as illustrated in FIG. 22. There, fine dust filter 213 is designed as an internally loaded hollow member 223 which is structurally separate from collection container 202 and which, via an opening 225 having an attachment collar 226 formed thereon, is in communication with chamber 224 extending between partition 204 and upper covering surface 209 (which has no filtering function here). Thus, the user can easily replace filter 213 without coming into contact with fine dust.

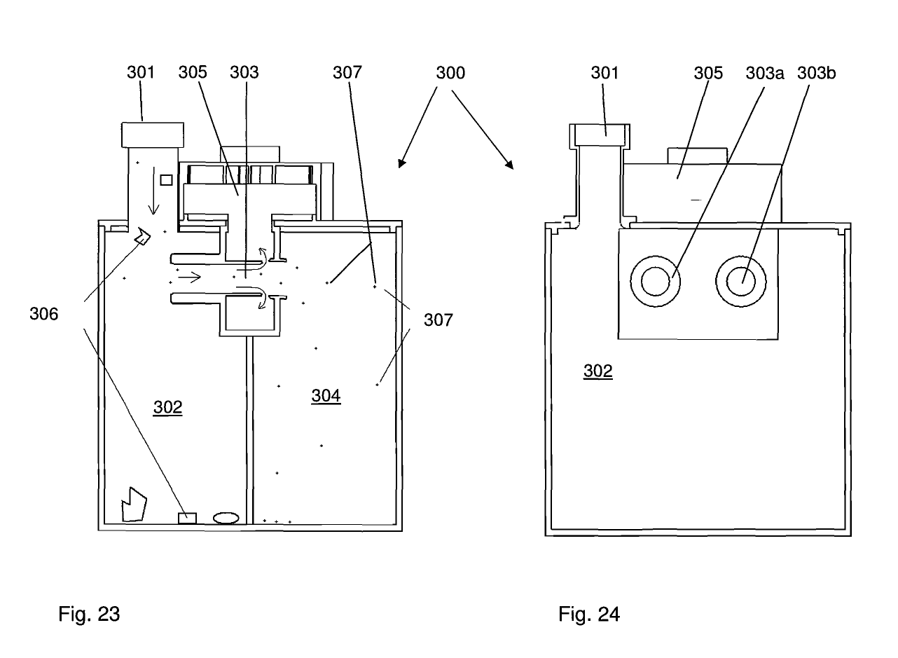

The above-described dust separators allow dust to be separated into two fractions: coarse and fine dust. If the intention is to prevent dust from being stirred up during emptying of dust separation container 201, a dust-binding agent can be added to container 201 as described above. Since the coarse dust constitutes about 90% of the total mass of dust, the consumption of dust-binding agent is very high. FIGS. 23 and 24 therefore disclose a dust separation container 300 that allows dust to be separated into a total of three fractions; i.e., the coarse dust is separated into a coarse fraction and a medium fraction (see also FIG. 16). The air laden with dirt 306, 307 enters, via a port 301, into a first collection container 302, in which the coarsest dirt fraction 306 is separated by gravity because of the reduced flow velocity. Smaller and lighter particles beyond 200 μm are passed on to annular gap separator 303 in spite of the reduced air velocity. There, a medium dust fraction 307 is separated and collected in a second collection container 304. The third and finest dust fraction (<30 μm) is carried by the air flow into the internally loaded fine dust filter 305 where it is separated.

This has the following advantage during emptying of the containers: The first fraction, which contains only coarse particles, can be emptied without stirring up any dust and without using a binding agent. Therefore, binding agent is needed only for the middle fraction. The amount required for binding can therefore be significantly reduced compared to methods where the first two fractions are collected in one container.

Another advantage is the greater freedom in the selection and constructional embodiment of the method for separating fine dust. This is because if only two fractions are produced, all flow paths must be designed such that they are suitable for the largest occurring particles. These are limited to about 30 mm by the inside diameter of the accessories. Since in the proposed method, these large particles are already retained in first collection container 302, a number of new options are available for separating fine dust:

Instead of an annular gap separator 303 having an inlet diameter of at least 30 mm, it is possible to use two or more smaller annular gap separators 303a and 303b connected in parallel, as shown in FIG. 24. For the same performance, a plurality of smaller separators offer less resistance to flow than a large one and are easier to incorporate into an available space.

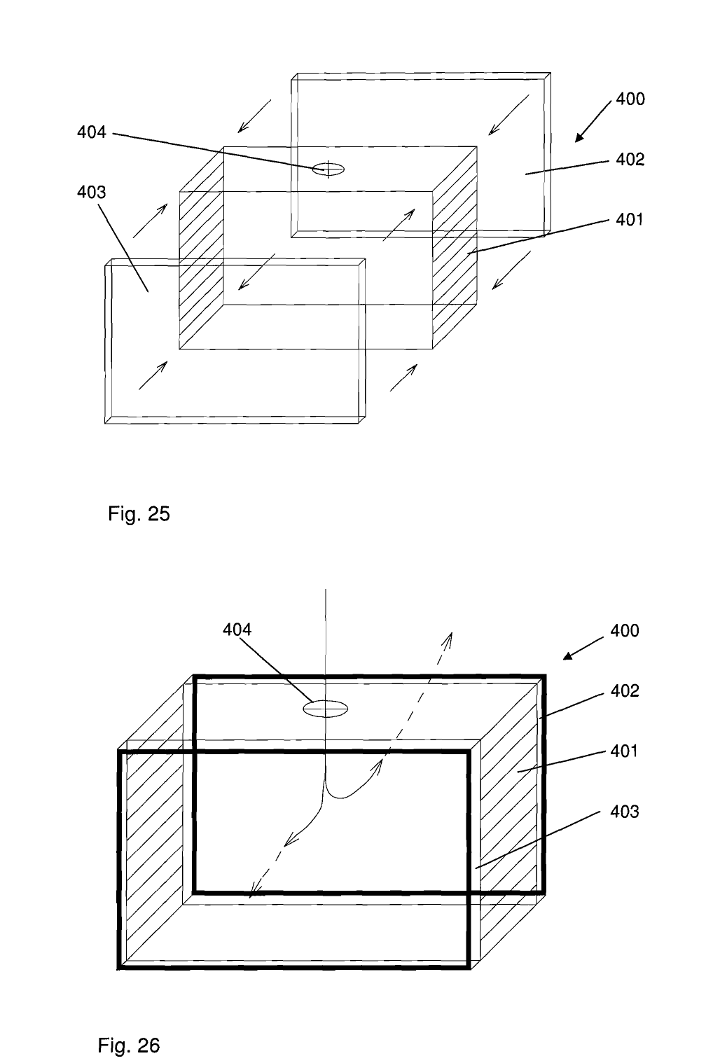

Fine dust filter 400, various embodiments of which are shown in FIGS. 25 through 29, is connected downstream of the above-described dust separation systems. Regardless of whether the system is designed as a cyclone separator (FIGS. 1 through 15) or whether it operates according to the principle of inertia/as an annular gap separator (FIGS. 19 through 24), fine dust filter 400 has the function of binding the particles that have passed through the pre-separator so as to prevent them from being returned into the ambient air. In accordance with the present invention, the dust separation system is designed to have a larger cut size than conventional systems and, therefore, only collects dust particles up to about 30 μm. Dust that is smaller than 30 μm (hereinafter be referred to as “fine dust”) for the most part enters fine dust filter 400.

FIGS. 25 and 26 illustrate the basic design of the proposed filter system, which is preferably configured as a rectangular cartridge. Front and rear filter media 402 and 403 are contained in a frame-like or rectangular holding member 401 which is open on the two large sides. Furthermore, air inlet 404 for the exhaust air from the dust separation system is provided in the upper side of holding member 401. Holding member 401 is preferably in the form of a rectangular folding frame. In another, alternative design, it is proposed to configure holding member 401 as a circumferentially closed, air-permeable, porous hollow member which also has filtering properties and in which filter media 402 and/or 403 are inserted, it being possible for filtering holding member 401 and internal filter media 402 and/or 403 to have different filtering properties. For example, holding member 401 may preferably be made of sintered plastic or a comparable material. This multi-stage filter system makes it possible to achieve the performance of very fine filters. The dimensions of the cartridge-like filter geometry are adapted to the spatial conditions of a commercial canister vacuum cleaner and should be in the range of a standard pack of vacuum filter bags, that is, H×W×D about 170 mm×230 mm×85 mm.

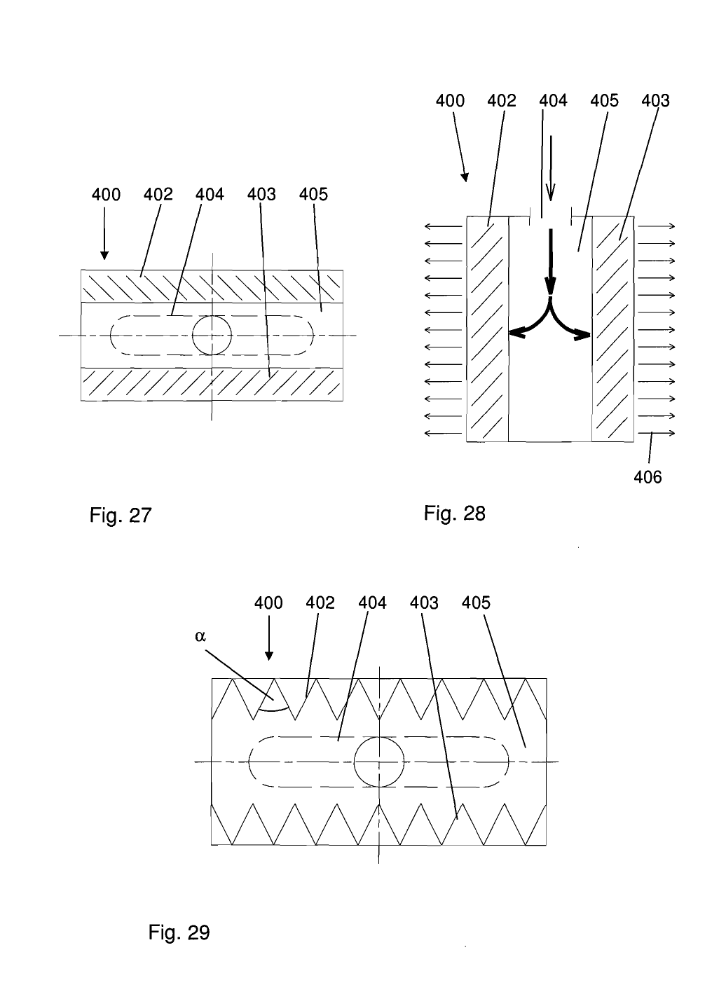

FIG. 27 and FIG. 28 are detailed views of one embodiment of the first design alternative, while FIG. 29 shows another embodiment of this alternative.

FIG. 27 is a top view showing fine dust filter 400 along with filter media 402 and 403 and air inlet 404. In this variant, filter medium 402, 403 is made of a highly retentive, mat-like filter fleece which is preferably electrostatically charged and may be natural or synthetically produced, the mat having a thickness of about 10 to 20 mm. Electrostatic charging is effected during manufacture of the filter fleece. Air inlet 404 is preferably configured as an elongated slot to ensure optimum flow onto filter medium 402, 403. FIG. 27 further shows the filter-material free hollow space 405 which is located between filter medium 402, 403 and air inlet 404 and which also promotes an optimum flow onto filter medium 402, 403.

FIG. 28 also shows the filter-material free hollow space 405 located between filter medium 402, 403 and air inlet 404. Moreover, the exhaust air flow from the dust separation system is symbolized by arrows 406. The filter system can be further improved by providing absorbent cotton or absorbent-cotton like material in hollow space 405 between the two filter media 402, 403. Tests have shown that especially smaller particles <15 μm can be effectively bound or retained in absorbent cotton.

FIG. 29 is a top view illustrating another variant. Here, filter medium 402, 403 is made of a highly retentive, thin filter fleece which is preferably electrostatically charged and may be natural or synthetically produced, the fleece layer having a thickness of about 4 to 7 mm. In order to achieve a comparable dust collection capacity while keeping the flow losses low, the filter fleece 402, 403 of this embodiment must be folded or pleated. “Pleating angle” α is about 30°. The pleating provides a large filtering area. When using the above-described filter mat, the capacity is mainly provided by a high level of depth retention.

### Method for Treating Dust and Devices for Carrying Out this Method

### Description

The present invention relates to a method for treating dust in a vacuum cleaner. The present invention also relates to various devices for carrying out such a method.

Vacuum cleaners, in particular canister vacuum cleaners, use dust retention systems which are generally disposed between the air inlet of a dust collection chamber and the suction side of a fan and which retain the collected dust before it enters the fan. The best-known variant is a filter which is in the form of a bag and which is internally loaded, i.e., dust accumulates inside the bag. Generally, a fine dust filter is disposed downstream of the bag, said fine dust filter collecting dust particles which have a size of less than 2 μm and which have passed through the bag. As the number of allergic persons increases, it is increasingly important to remove this dust fraction from the ambient air because such particles are respirable because of their small size and, therefore, may have adverse effects on health. When the maximum collection capacity of about 400 grams is reached, the bag needs to be replaced. In the case of sealable bags in particular, this can be done in a hygienic manner, since the dust remains in the bag and is disposed of therewith. Depending on usage, replacement is required several times a year, which generates costs. The fine dust filter also needs to be replaced after a certain period of use, but the intervals are longer here because of the small amount of fine dust. Manufacturers recommend replacement after about one year. Due to the small particle sizes, the mass fraction of fine dust produced is small and, therefore, commercial fine dust filters have a capacity of about 10 grams.

Some mini vacuum cleaners, multipurpose vacuum cleaners, or industrial appliances use externally loaded filters, which enclose the fan. The advantage is the higher collection capacity, while the disadvantage is that the filters of such vacuum cleaners are designed only for coarse dust. The fine dust, which contains allergenic pollens and microorganisms, passes through the filter and is blown back into the room by the fan, and is even stirred up in this process.

There is a desire for a filter system for coarse dust that can be reused and has the following features:

a compact design;

a filter performance comparable to that of a dust bag;

hygienic removal of the collected dust;

low losses in suction power.

The systems known in this connection are primarily the following:
1. washable and reusable textile filter bags (DE 199 11 331 C1). There are concerns with such bags, primarily with regard to hygiene, because the heavily soiled bags must first be manually emptied and then washed in a washing machine.
2. dust cartridges made of porous sintered material (EP 1 179 312 A2);
3. centrifugal separators, called “cyclones” (EP 0 647 114 B1).

The latter two systems allow the dust collection container to be easily removed, emptied, and cleaned if soiled. Conventional systems, in particular cyclone separators, attempt to simulate the dust separation known from dust bags. For this reason, the cut size of the separators is very small. Accordingly, due to the low degree of separation sharpness, the dust collection containers contain large quantities of respirable fine dust. As a result of this, during emptying of such containers, the lighter fractions of the dust being removed fly up and are dispersed in the air. This may have adverse effects, especially on people with allergies.

It is therefore an object of the present invention to provide a method for treating dust and devices for carrying out such a method, by which disposal is improved from a hygiene point of view.

This object is achieved by a method having the features of claim 1, and by devices having the features of the other independent claims.

In accordance with the present invention, the dust is separated into at least two fractions which differ in the size or mass of the dust particles, and a dust-binding agent is added to a fraction, so that the dust is not just loosely deposited in a dust collection chamber, but is bound and interlinked to a certain extent, and that no swirling occurs when emptying the dust collection chamber. In this manner, exposure to fine dust, pathogenic particles, or other harmful substances is reduced, and the handling of the dust collection chamber, which needs to be emptied at regular intervals, is made significantly more hygienic. Moreover, the contents of the dust collection chamber can be disposed of at once as a mixture, for example, as a lump.

The fraction of the dust particles which for the most part are smaller than the fraction to which a dust-binding agent is added can then advantageously be collected by a fine dust filter. This prevents particles of this fraction from being returned into the ambient air and being dispersed therein.

In a particularly advantageous embodiment, the dust is separated into three fractions which differ in the size and/or mass of the dust particles, and a dust-binding agent is added to the fraction of the dust particles which for the most part are of medium size or mass. The first fraction contains only coarse particles and can be emptied without stirring up dust and without using any binding agent. Therefore, binding agent is needed only for the middle fraction. The amount required for binding can therefore be significantly reduced compared to methods where the first two fractions are collected in one container.

The devices used for separating the dust should be dimensioned such that the first fraction contains mainly dust particles having a size larger than 200 μm, that the second fraction contains mainly dust particles having a size of between 200 μm and 30 μm, and that a third fraction contains mainly dust particles having a size of less than 30 μm. A portion of the particles of the third fraction have a size of up to 30 μm and are therefore still very large, which results in a requirement for a fine dust filter having a very high collection capacity. However, in this manner, the number of respirable fine dust particles contained in the second fraction is kept very low, even if the sharpness of separation is low. In this manner, hazards which may occur to users when emptying the container of the second fraction are prevented or kept to a minimum, even if they decide not to use a dust-binding agent, or if they forget to add it.

It is also advantageous if the dust-binding agent is added into a dust collection container that can be inserted into the vacuum cleaner and removed therefrom. On the one hand, this allows for easy removal of the conglomerate of dust and dust-binding agent without requiring additional containers and, on the other hand, enables easy cleaning of the dust collection container.

With regard to other suitable or even advantageous embodiments of the method according to the present invention, reference is made to the further dependent claims 6 through 19.

A device according to the present invention for carrying out the above-described method has means by which dust picked up by a vacuum cleaner is separated into at least two fractions which differ in the size of the dust particles, the device further having means for adding a dust-binding agent into the fraction contained in a dust collection container, and a fine dust filter for collecting the fraction of the dust particles which for the most part are smaller than the fraction to which a dust-binding agent is added.

One suitable device for separating the dust operates according to the principle of inertia. It is used in a vacuum cleaner including an air inlet, an air outlet, and a rigid-walled collection container. The air inlet and the air outlet are separated from the collection container by a partition having an opening. Moreover, the air inlet, air outlet, and the partition and its opening are arranged so as to cause an abrupt change in direction of the air flow in such manner that dust particles of a predetermined minimum size are separated from the air flow and retained in the collection container below the partition. A device of this kind can be used to advantage in conjunction with a dust-binding agent, but can also be used in vacuum cleaners whose collection containers are emptied conventionally without adding a dust-binding agent.

A separator device of this kind has the advantage of separating coarse and fine dust inside the container, which allows for hygienic emptying. The collection container can be emptied without stirring up dust, because only small amounts of fine dust are contained in this container. The fine dust can advantageously be neutralized by the dust-binding agent.

To this end, it is advantageous if the outlet openings and the fine dust filter extend in the upper covering surface and in the side walls adjacent thereto (claim 29). Another advantage ensues from the compact design, which allows for adaptation to the inner contours of a dust collection chamber of a vacuum cleaner, in particular of a canister vacuum cleaner (claim 31).

In accordance with the present invention, the air inlet of the container is formed in a covering surface of the container, and the partition is disposed such that it approximately parallel to the covering surface, at least in the region of its opening (claim 22).

In an advantageous embodiment, the opening in the partition is surrounded by a collar directed toward the air inlet (claim 23). Thus, the space between the upper covering surface and the partition is increased and has sufficient collection capacity for the fine dust. Moreover, the volume flow through the annular gap is smoothed, even if the air inlet opening is disposed asymmetrically within the fine dust filter.

Optimum deflection of the air flow is achieved by the fact that both openings are circular in shape and form a cylindrical or frustoconical gap (claim 24). The width of the gap should be such that the cylindrical or frustoconical lateral area formed by the gap is approximately equal to the cross-sectional area of the air inlet opening (claim 25). This prevents turbulences from occurring in the collection chamber.

In a further advantageous embodiment, the partition is provided with a bypass opening (claim 26). This prevents the coarse dust from being stirred up in the collection container, because the positive pressure resulting from the swirling of air is removed from the collection container.

To facilitate handling during the emptying operation, the collection container is removable from the remainder of the container (claim 27). The dust separation container is of an advantageous construction because it includes, in addition to the collection container, a cover and the partition; the cover including the air inlet, openings for air outlet, and a fine dust filter (claim 28). Thus, the partition and the cover can be formed separately, which, on the one hand, facilitates production and, on the other hand, allows for easy removal of the fine dust filter for cleaning.

A particularly advantageous dust separation container has at least two collection containers for collecting dust fractions of particles of different sizes or masses, said containers being fluidically arranged in series. These containers should be designed such that the cut size of the first container is about 200 μm and the cut size of the second container is about 30 μm. The first fraction, which contains only coarse particles, can be emptied without stirring up dust and without using any binding agent. Therefore, binding agent is needed only for the middle fraction. The amount required for binding can therefore be significantly reduced compared to methods where the first two fractions are collected in one container. Moreover, a dust separation container of this kind can also be used without using a dust-binding agent, especially by people who are not allergic, because the second fraction contains only a very small amount of respirable fine dust particles, even if the sharpness of separation is low. In this manner, hazards which may occur to users when emptying the container of the second fraction are prevented or kept to a minimum, even if they decide not to use a dust-binding agent, or if they forget to add it.

A device according to the present invention for adding a dust-binding agent into the dust collection container can be disposed as externally, separately from the vacuum cleaner, internally in the vacuum cleaner, or in a vacuum attachment of the vacuum cleaner. Suitable or even advantageous embodiments of such a device are disclosed in dependent claims 37 through 54.

A suitable fine dust filter should have a collection capacity of at least 200 grams. Since, because of the cut size of 30 μm, particles of relatively large size and mass reach the fine dust filter, a commercial fine dust filter having a collection capacity of about 10 grams would be quickly saturated. This would contradict the idea of a vacuum cleaner that is designed to use no, or only a small amount of, consumables. For this reason, a filter capacity is selected that guarantees a service life of over one year given normal use. In addition to the increased service life, a further advantage obtained is that the flow loss is only about 20 percent (at the end of the service life, relative to the initial condition). A filter of this kind is preferably used in a vacuum cleaner that uses a dust-binding agent for the next larger fraction. However, such a filter can also be used without a dust-binding agent, especially if the cut points of the dust separation container are so sharp that the next larger fraction does not contain any respirable particles.

Suitable or even advantageous embodiments of such a fine dust filter are disclosed in the following dependent claims 56 through 65.

The present invention will be explained in more detail below with reference to several exemplary embodiments and the accompanying drawings, in which:

FIG. 1 is a schematic view of an exemplary embodiment of a vacuum cleaner according to the present invention;

FIG. 2 is a perspective exploded view of the dust collection chamber of the vacuum cleaner shown in FIG. 1;

FIG. 3 is a top view of the vacuum cleaner of FIG. 1;

FIG. 4 is a cross-sectional side view of a dust collection chamber having a dispensing device;

FIG. 5 is a partially cross-sectional view of another exemplary embodiment of a dust collection chamber having a dispensing device;

FIG. 6 is a partially cross-sectional view of a further exemplary embodiment of a dust collection chamber, which has a heating means;

FIGS. 7a, b are two views of a dust collection chamber according to an alternative embodiment;

FIG. 8 is a schematic view of a separate device for binding dust; and

FIG. 9 is a detailed cross-sectional view showing the device of FIG. 8 with a cartridge;

FIG. 10 is a view of a dust collection container having a pressing device;

FIG. 11 is a view of a dust collection container having an agitator;

FIGS. 12a, b are views of another alternative for binding dust;

FIGS. 13 through 15 are views showing a vacuum cleaner and a dust collection container in which an electromagnetic field is used to bind dust;

FIG. 16 is schematic view of a three-fraction dust separator;

FIG. 17 is a view of a dust collection container having a water inlet;

FIG. 18 is a view showing the dust collection container of FIG. 17 during emptying;

FIG. 19 is a cross section through a dust separation container 1 designed in accordance with the present invention;

FIG. 20 is a top view of dust separation container 1 of FIG. 1;

FIGS. 21, 22 are views of further embodiments of dust separation containers 1 designed in accordance with the present invention;

FIGS. 23, 24 are views of a particularly advantageous embodiment of a dust separation container designed in accordance with the present invention, in which dust is separated into three fractions;

FIGS. 25, 26 are views illustrating the basic design of a fine dust filter according to the present invention;

FIGS. 27, 28 are detailed top and side views of a first embodiment of the fine dust filter;

FIG. 29 is a top view of a second embodiment of the fine dust filter.

FIG. 1 is a purely schematic view in longitudinal section of a vacuum cleaner 1. Vacuum cleaner 1, as usual, includes a housing 2, which is divided into a fan chamber 3 and a dust collection chamber 4. Dust collection chamber 4 is closed by a hinged cover 5 and has a first opening 6 at which the coupling 7 of a suction hose 8 ends. Various vacuum attachments (not shown) can be attached to suction hose 8, possibly via a suction wand (also not shown) interposed therebetween. A second opening 9 is provided in partition 10 between dust collection chamber 4 and fan chamber 3. A fine dust filter 11 is located behind this opening 9. A motor fan 12 is mounted in fan chamber 3 behind the fine dust filter. The suction side of the fan faces fine dust filter 11 and opening 9, while its discharge side is in communication with ambient air 13 via further openings 18, which may have a filter (not shown) placed upstream thereof. Located above the fan chamber is a compartment 14 for receiving an appliance controller, and controls and indicators (see FIG. 3). When fan 12 is turned on, dust-laden air (symbolized in the figure by arrow 16) is passed in known manner through suction hose 8 and through dust collection chamber 9, in which a bagless dust collection system is placed to separate coarse dust 17 therein. In the exemplary embodiment shown, said system is a cyclone separator 20, but it is also conceivable to use the variants mentioned at the outset, namely an inertial separator or a dust cartridge. The separator used is tailored such that a fraction of particles which for the most part are larger than 30 μm is collected within the dust collection chamber.

FIG. 2 is a detail view of cyclone separator 20. The cyclone separator includes a cyclone cone 21 provided with an air inlet 22 and an air outlet 23. Air inlet 22 is in fluid communication with opening 6, while air outlet 23 is in fluid communication with opening 9 via conduit 15 (see FIG. 1). Cyclone cone 21 is inserted into a cylindrical container 24 which, as shown in the figure, may be divided into a tubular holder 25 and a dust collection container 26 located therebelow. The dust-laden air drawn in is set into rotary motion in cyclone cone 21 so that, according to the centrifugal principle, coarse dust 17 is thrown against the outer wall, whereupon it falls down into dust collection container 26. The fine dust is separated by fine dust filter 11 in the downstream path of the air. When container 26 is full, which can be detected by filling-level, pressure, or dust-quantity sensors, or simply by measuring the ON-times of the fan (not shown), the user is informed of this condition via an indicating device 35 (see FIG. 3).

FIG. 3 is a top view of a vacuum cleaner 1 designed in accordance with the present invention. A control panel 30 includes the known controls and indicators, such as an ON/OFF switch 31, a replacement indicator 32 for fine dust filter 11, a cord winder button 33 and a power controller 34, and, in addition, is provided with further elements, whose function will be explained later. These further elements may include the above-described indicator 35 for emptying of dust collection container 26. In the following exemplary embodiments (FIGS. 4 and 5), the replacement indicator is activated by a piezoelectric sensor known from EP 0 759 157 B1, which provides to the appliance controller (symbolized in the figure by dashed-line box 36) a signal that correlates with the quantity of dust that has been picked up. The user can then separate dust collection container 26 from the remainder of cyclone separator 20 and remove coarse dust 17. This is where the present invention comes in:

In order to prevent the coarse dust from being stirred up during emptying of the dust collection container, a dust-binding agent is added thereto. A dust-binding agent in accordance with the present invention is a single- or multi-component additive which is present in the solid and/or liquid and/or gaseous phase, the phase possibly being able to be changed in order to permeate and mix the loose, unbound dust that has been drawn in [sic], and to bind the dust, at least partially. The dust-binding agent is intended to bind fine dust, germs, bacteria, pollens, and other harmful substances present in the dust collection container, in addition to the coarse dust, to prevent them from being stirred up and causing adverse effects to the user during disposal. Thus, the filled dust collection chamber can be emptied in an hygienic manner and without stirring up dust. Dust-binding agents that can be used include suitable dispersible liquids, powder, foam, granular material, or solid substances, especially in pelletized form. Moreover, it is possible to add scents, cleaning or anti-germ substances to the dust-binding agent. The dust-binding agent is added into the dust collection container by means of a suitable device, which may either be incorporated within the vacuum cleaner or be integrated into a vacuum attachment, or it may be constructed as an external device having a receptacle for the dust collection container.

FIGS. 4 and 5 show exemplary embodiments of dust collection containers into which a dust-binding agent is added and mixed with the dust. The dust-binding agent may be a liquid, powder, foam, or granular material, or mixtures thereof. In particular when using granular material, a substance which improves the adhesion of dust should be added thereto. Moreover, the dust-binding agent can be supplemented with agents having cleaning activity, such as by adding surfactants or other substances that promote cleaning action. It is also possible to add bacteriocidal, bacteriostatic and/or fungicidal agents in order to prevent germs from growing inside the dust collection container. Such properties can be obtained, for example, by doping the material with silver ions. Furthermore, it is possible to use scents to make the handling of the dust collection chamber more pleasant.

In order for the dust-binding agent to perform its function in accordance with the present invention, it must be brought into contact with the dust. The dispensing of dust-binding agent can be done in the following ways:
The dust-binding agent is dispensed directly into the dust collection container by the user. This option is extremely cost-effective, because there is no need for any active elements to be installed in the vacuum cleaner, but has the disadvantage that the user may come into contact with the collected dust before it is bound. In order to overcome this disadvantage, the dust-binding agent can be drawn in by turning on the fan.
The dust-binding agent is dispensed into the dust collection container by a dispensing device. Activation is via actuating means provided on the vacuum cleaner, on the vacuum attachment, or on the external device.
The dust-binding agent is automatically dispensed by the vacuum cleaner or by the vacuum attachment. This may be done while the fan is ON by suitable dispensing devices in the region of the air inlet, or directly into the dust collection container.
The dust-binding agent is dispensed at the beginning of a vacuuming process; the quantity required for the dust collection container being added either at once after the emptying process or in several steps. Moreover, the dust-binding agent can also be added after the vacuuming process. With respect to quantity, time of addition and/or frequency of addition, the activation of the dispensing device required for this purpose can be controlled as a function of time, filling level or dust quantity. This can be done using the same devices as those used for the replacement indicator described at the outset.
The dust-binding agent is added automatically when inserting the dust collection container.

It is advantageous to use means for mixing the dust with the dust-binding agent, especially if the agent is added at the beginning or end of the vacuuming process, or if it is added in an external device. To this end, it is possible to use mechanical or motive means which set the container into motion, rotation, or vibration.

In the exemplary embodiment shown in FIG. 4, air inlet 22 has disposed therein a dust-quantity sensor 41 which measures the quantity of dust passing therethrough. Air inlet 22 further has provided therein a dispensing device 42 for a dust-binding agent 43 in the form of powder and/or granular material. The quantity measured by dust-quantity sensor 41 is transmitted to appliance controller 36. If the detected quantity indicates that collection container 26 must be emptied, said appliance controller causes the dust-binding agent to be dispensed via a dispensing flap 44 into air inlet 22 and to be dispersed in the still dust-laden air therein. By subsequently swirling the air, dust 17 and dust-binding agent 43 together, an optimum mixing is achieved. Dust-binding agent 43 and dust 17 are collected together in container 26, and can then be disposed of at regular intervals. The dispensing of dust-binding agent 43 can be done via flaps, pistons, screws and/or nozzles. The addition of the dust-binding agent can be done either directly in dust collection chamber 26 or in the region of air inlet 22; it being possible for the addition to take place, for example, already at the vacuum attachment of vacuum cleaner 1 (not shown).

FIG. 5 shows another embodiment of a dust collection container 26, in which coarse dust 17 is bound. To this end, at least one spray device 50 is provided on container 26, said at least one spray device being usable to dispense a fluid 52 into dust collection chamber 26. Spray device 50 includes a reservoir 53 in which fluid 52 is contained as a dust-binding agent. Also provided are dispensing pumps 54 which can be activated by appliance controller 36 and which are used to convey liquid dust-binding agent 52 into dust collection container 26 through hoses 55. To this end, there are provided one or more nozzles 51 from which the fluid 52 conveyed through hoses 55 is dispensed into dust collection chamber 26 and atomized. The dispersed, dust-binding fluid 52 is symbolized by the spray 56. Dust-binding agent 52 may be a glycol- or glycerol-containing liquid which reduces the surface tension to values of less than 40 mN/m and to which may be added fungicidal, bacteriostatic and/or bacteriocidal components. It is also conceivable to use a highly diluted adhesive, such as wallpaper paste. However, liquid dust-binding agent 52 should preferably be dispersible. If the dispensing pumps and nozzles are suitably designed, powdery, foamy, or granular media may be sprayed in place of a fluid. It is also possible to use, in place of pumps 54, other pressure-generating elements for dispensing purposes. Furthermore, dust-binding agent 52 can also be added via controllable valves and dispersed by ultrasound. Here, too, the supplying of liquid dust-binding agent 52 can be controlled as a function of the data provided by a dust-quantity sensor 41 but, alternatively, may also be controlled using one of the alternatives enumerated above. For economic production, the walls of dust collection chamber 26 can be made from plastic. Of course, it is also possible to provide a non-stick coating to facilitate cleaning.

FIG. 6 shows an exemplary embodiment of a dust collection chamber 26 in which dust 17 is bound by a substance which is first melted, then takes up dust 17 and subsequently cools, after which it can be removed from dust collection chamber 26. For this purpose, paraffin 60 may be used and added to the container as a pellet 61 or granular material 84 (see FIG. 9). Container 26 is provided with a heat source 62 which is supplied with electrical power by a power supply 63.

As can further be seen in FIG. 6, a support 64 for paraffin pellet 61 is provided on the bottom of container 26. Also schematically shown is the dust 17 lying on paraffin pellet 61. Container 26 may be removed from vacuum cleaner 1 and cleaned at regular intervals.

During vacuuming, the house dust is first fractionated by cyclone separator 20, during which process particles having a diameter <30 μm pass through cyclone separator 20 and are bound in fine dust filter 11. All other dust particles 17 fall onto paraffin 60 because of gravity. When a certain filling level is reached, the heat source, which is in the form of a heating plate 62, is supplied with electrical power by power supply 63, whereby paraffin 60 is transferred from the solid to the liquid phase. It is also possible to use the heat generated by fan 12.

The density of paraffin 60 is on the order of <1 g/cm³, approximately in the range between 0.5 and 0.7 cm³. According to the Archimedes principle, all bodies having a density >about 0.8 g/cm³ will sink into paraffin 60. This condition is satisfied by house dust particles 17 having a density in the range >1 g/cm³. Due to the density ratio between the individual substances, and because it is relatively easy to produce a phase change of paraffin pellet 61, the dust 17 present in container 26 can be easily bound and caused to sink into paraffin 60. When the filling level of container 26 reaches a sufficient height, the cooled lump of paraffin 60 and bound dust 17 can be disposed of without stirring up dust. It is especially because of the non-polar molecular structure and the low surface tension of paraffin 60, that, other than in the case of water, particles can generally sink very easily into paraffin 60 when the paraffin in the liquid phase. Furthermore, the melting point of paraffin 60 can be adjusted in a wide range.

In order to allow for easy removal of the solidified paraffin 60 from dust collection container 26, paraffin pellet 61 is located in the region of support 64, which is made of a repulsive (non-stick) material, or a material having a repulsive surface, preferably silicone. The support can also be made of Teflon-coated aluminum because of the superior thermal conductivity thereof. Support 64 can be detachably received in container 26 to allow it to be removed and replaced with a new paraffin pellet 61, possibly with a new support 64 [sic].

In addition to substances which can be caused to change their phase by supplying heat energy, it is also possible to use as the dust-binding agent so-called thixotropic substances, whose viscosity can be changed by kinetic energy. Examples of such substances are cellulosic suspensions.

FIGS. 7a and 7b show a dust collection container in the form of a removable cartridge 70, which forms part of the dust collection chamber 4 of a vacuum cleaner 1, as is shown, for example, in FIG. 1. Unlike the preceding exemplary embodiment, cartridge 70 is formed by a cup-shaped container 75 which can be closed by a cover 71. Cover 71 is provided with handles 72 and a central closure member 73. Again, a paraffin pellet 61 is provided as a dust-binding agent in cartridge 70. The bottom of cup-shaped container 75 can also be made of a repulsive (non-stick) layer, such as Teflon or coated aluminum. To ensure that the melting heat is efficiently transferred to paraffin pellet 61, the bottom may be made of metal, such as aluminum. The side wall portion of container 75 can be made of a flexible material, preferably silicone, to allow for easy removal of the paraffin pellet 61. Furthermore, container 75 can be easily cleaned and used multiple times. At the bottom of container 75, there is also provided a socket 74 in which a drive shaft can be engaged.

FIGS. 8 and 9 show a separate add-on device 80 for binding the dust 17 contained in cartridge 70. Add-on device 80 essentially includes an upper part 81 and a lower part 82, which are separably and/or movably joined together. Thus, cartridge 70 can be inserted into add-on device 80 after removal of upper part 81. In addition to a feed funnel 83 for a dust-binding agent, such as granular paraffin 84 or paraffin powder, upper part 81 includes a control and display unit 85 having a controller 86. Controller 86, which may be a microcontroller, includes a program which is specifically designed for the binding of dust and has defined steps and parameters, and which can be controlled via control and display unit 85. Furthermore, control and display unit 85 shows the current status of the dust-binding process.

After inserting cartridge 70, dust-binding agent 84 can be added manually or automatically via a gate 91. Thus, granular paraffin 84 serves to seal the mixture of paraffin 60 and dust 17 present in container 75.

Lower part 82 serves to receive cartridge 70, which is placed on a shaft 87 of a drive mechanism 88. Drive mechanism 88 sets cartridge 70 into motion, preferably into rotary motion in continuous and/or pulse mode. The rotation ensures a better mixing of paraffin 60 with dust 17 during the liquid phase due to the action of the centrifugal force.

Moreover, cartridge 70 rests with its bottom on a heat source 89 for melting a paraffin pellet 61. Heat source 89 is also movably mounted, and can be moved in a vertical direction by drive mechanisms 90. Whenever dust container 75 rotates, heat source 89 is lowered. All drive mechanisms 88 and 90, and heat source 89, are activated by controller 86 according to the program. Furthermore, upper part 81 or lower part 82 may have provided therein cooling devices (not shown), such as fans or Peltier elements, in order to accelerate the solidification of paraffin 60.

In order to dispose of dust 17, first, the filled dust cartridge 70 is inserted into add-on device 80. Then, heat source 89 is energized until paraffin pellet 61 has melted. After that, heat source 89 is turned off, and cartridge 70 is lowered onto shaft 87 of drive mechanism 88. Then, cartridge 70 is rotated, whereby dust 17 and molten paraffin are mixed. Moreover, granular paraffin 84 may be added via gate 86. Subsequently, dust cartridge 10 is stopped, and the liquid paraffin 60 is cooled. After that, dust cartridge 70 can be removed, and the mixture contained in cartridge 70 can be disposed of.

In addition to the described methods of application of the dust-binding agent, preferably paraffin, it is also possible to press the dust into the liquid paraffin so as to minimize the use of dust-binding agent. FIG. 10 shows a dust collection container 26 which is equipped with such a pressing device 100. To this end, removable dust collection container 26 has a compression plunger 101 provided therein which is driven manually or automatically, i.e., by electric motor means or aerodynamically, and is thereby pressed onto coarse dust 17 and the binding agent. After heating plate 62 is energized, the dust is pressed into the liquid binding agent, preferably paraffin 60, whereby a press cake containing dust and binding agent is produced by compaction. The pressing process can be carried out each time the vacuum cleaner is turned off, or when the collection container is completely filled.

It is also possible to mix the dust with the dust-binding agent using an agitator. To this end, an agitator 110, which is driven by a rotating shaft 111, either manually or automatically, is disposed in the dust collection container 26 shown in FIG. 11. Blades 112 of agitator 110 are partially or completely covered by coarse dust 17. A dispensing device 113 containing dust-binding agent 114 is located within or above the dust collection container. Binding agent 114 is dispensed onto coarse dust 17 either continuously (e.g., during operation) or discontinuously (e.g., at each power-on or when the dust collection container is completely filled). Using agitator 110, binding agent 114 is homogenously mixed with dust 17, which makes it possible to minimize the use of binding agent.

FIGS. 12 and 12b are schematic views illustrating the basic design of another option for binding dust. Here, pads 120 are placed into the dust collection container to completely cover the bottom. Pads 120 are formed by at least two components, a first retention medium 121 including a dust-binding agent 122, and a second retention medium 123 for coarse dust 17. Pads 120 are preferably designed as consumables. The material of the first retention medium is porous to coarse-porous, sponge-like and liquid-retaining, it being preferred to use foamed plastic. The material is impregnated with a liquid dust-binding agent 121. Ideally, dust-binding agent 121 is in the form of a liquid having a low vapor pressure, such as glycerol or glycol. Second dust-retention medium 123 must be permeable to liquid and capable of retaining liquid, have coarse pores, and be fibrous in nature. Preferably, cellulose fibers are used at this location, the fibers being injected into the foamed plastic so as to provide good contact with dust-binding agent 121. Cellulose fibers have a high capillarity, whereby dust-binding agent 121 is transported from the foamed plastic to the surface of second retention medium 123 in order to wet and bind the dust 17 there, and thereby to prevent dust from being stirred up. Thus, a “dust cake” is formed on the surface of retention medium 123 in the course of time, see FIG. 4b. When the capacity of first retention medium 122 is saturated, pad 120 is preferably removed through bottom closure member 124 of dust collection container 26 along with the bound dust 17, without stirring up dust.

FIGS. 13 through 15 are schematic views showing another bagless vacuum cleaner 1 and the dust collection container thereof. At the heart of this embodiment is a device for generating an electromagnetic field which promotes the tendency of coarse dust 17 to agglomerate in dust collection container 26, so as to allow for hygienic removal of the dust without using an additive in the form of a binding material. Real house dust has a tendency to form agglomerates due to its composition (mainly organic constituents). Thus, preferably allergens, such as pollens and mite excrements, bind with larger particles in the house dust. The reasons for this are electrostatic forces due to polarization, and adhesion forces due to a sticky particle surface. By using the device shown and the method described below, the inherent binding forces of the house dust are intensified while preventing stirring up of dust, especially of fine dust and allergens.

FIG. 13 shows the basic design of such device disposed in bagless vacuum cleaner 1 for this purpose. The essential components of the device include two opposite, in particular plate-shaped electrodes 131 and 132, and a high-voltage generator 133. High-voltage generator 133 may be a belt generator aerodynamically driven by the vacuuming air flow of the vacuum cleaner, or an electronic voltage multiplier circuit which derives the high voltage from the mains voltage. Both the high-voltage generator 133 and electrodes 131 and 132 are used to generate a preferably electric field, symbolized by dashed arrow 134. Electrodes 131 and 132 constitute an active capacitor-like system or structure.

FIG. 14 (perspective view) and FIG. 15 (cross-sectional view) illustrate the design of the device in detail. As is shown in FIG. 14, the dust collection system of the bagless vacuum cleaner is mainly formed by cylindrical dust collection container 26 and air inlet 22. Due to the force of gravity, the coarse dust 17 that has been drawn in settles in the bottom region of dust collection container 26. Inside the dust collection container, there are located the two opposite, contour-adapted electrodes 131 and 132 which form a capacitor, the upper electrode 131 being movable (automatically or manually) so that the distance between the plates can be reduced by the translational movement. Lower electrode 132 is located in the bottom region of dust collection container 26. Thus, dust 17 constitutes the dielectric of the capacitor. Both capacitor electrodes 131 and 132 are connected to high-voltage generator 133 via a switch 136 controlled by microcontroller 135. Electric field 134 forms between the two electrodes 131 and 132. Thus, movable electrode system 131 and 132 constitutes a dust press in the form of a capacitor, the pressing effect being increased by adding electric field 134.

To further illustrate the present invention, FIG. 15 shows a cross-sectional view of the device already described. Preferably, lower electrode 131 is designed such that it can be tilted or pivoted to allow removal of the compressed dust. The high voltage generated by high-voltage generator 133 is preferably a steady-state DC voltage in the range of 1 kV to 3 kV. By compressing the dust with the assistance of the added electrostatic field, polarization effects in the dust are intensified and adhesion forces are used more effectively, so that the binding of dust takes place “by itself”, i.e., without any additive material, and no dust is stirred up during removal. The pressing process assisted by the added electrostatic field is preferably carried out when the dust collection container is full. In another possible alternative, the execution of the pressing process could be controlled as a function of the dust quantity with the aid of a sensor 41 (see FIG. 4). In addition, it is possible to initiate pressing each time the fan is turned on. Moreover, the pressing parameters, such as the pressing time and the level of the high voltage, can be varied according to the signal of dust-quantity sensor 41. The use of a device for pressing dust 17 with the assistance of an added electrostatic field in a bagless vacuum cleaner 1 has the advantages that the dust can be disposed of in a hygienic manner without stirring up dust and without using a bag and/or any other binding agent material and that no fine dust problem occurs during removal.

The device for generating the electromagnetic field can be positioned within, above, or below the dust collection container. Moreover, it can be an active, i.e., generator-type of a device, may be formed of multiple parts, or be designed as a capacitor. The field can be constant or variable, stationary or transient in space or time. There are at least two electrodes, one of which may form the bottom of the dust collection container. The electrodes may be plate-shaped, contour-adapted, or round, disposed opposite each other, linearly movable, and one electrode may be pivotable. The electrode spacing may be variable, for example, by motor means or manually. The generator used for operating the device may operate triboelectrically (example: an aerodynamically driven belt generator) or electronically (example: a voltage multiplier circuit); the high-voltage signal may be a DC or AC signal of high frequency. The activation of the generator and the pressing may take place once (when the container is full), repeatedly (after each power-on), continuously, discontinuously, or may be controlled as a function of the dust quantity. One electrode can swing out of the way during removal.

In another variant, water is used as the dust-binding agent. FIG. 16 schematically shows a three-fraction dust separator 160 including a coarse dust container 161 containing coarse dust (first fraction 162), a container 163 for the second (medium) dust fraction 164, and a find dust filter 165 containing fine dust (third fraction 166). The construction of the overall separator is described elsewhere herein.

The dust entering dust separator 160 is divided as follows:

Coarse dust 162 for the most part contains particles having a size greater than about 200 μm. These particles are collected in coarse dust container 161. Particles which for the most part have a size in the range from about 30 μm to about 200 μm are collected in dust collection container 163, while particles smaller than 30 μm for the most part enter fine dust filter 165. In these considerations, it must be kept in mind that the cut points are not sharp. Therefore, second fraction 164 also contains fine dust 166, which is known to have a tendency to be stirred up during removal. Therefore, the dust collection container 163 used for second dust fraction 164 is a container which, together with the application of water 170, allows for hygienic removal of the dust.

FIG. 17 is a view showing the construction of a suitable dust collection container 163 along with dust 164, a dust inlet 171 having a flap valve 172, a water fill valve 173, a bleed valve 174, a chute 175, an outlet opening 176, and a chute inlet 177. Water 170 is excellently suited for binding dust. Using the water filled in through water fill valve 173, dust 164 in dust container 163 is mixed with dust 164, possibly by agitating container 163. In the position shown in FIG. 17, chute 175, and its outlet opening 176, is closed, and bleed valve 174 is not actuated, i.e., closed.

FIG. 18 shows dust collection container 163 during emptying. After water 170 and dust 164 are thoroughly mixed, a water/dust mixture is produced, which can be discharged through outlet opening 176 and funnel-shaped chute inlet 177 by pivoting the chute 175. The amount of water added is such that a free-flowing mixture is produced. For purposes of emptying, bleed valve 174 must be opened. Advantageously, the inner walls of dust collection container 163 and all other component parts are treated or coated with a non-stick coating (lotus effect). To be able to empty containers 161 and 163 separately, they are separable from each other. In order to prevent confusions, it is it is advisable that the embodiments have different visual characteristics, in particular different colors. Using water 170 as the dust-binding agent has the advantage that dust 164 can be disposed of in a hygienic manner without stirring up dust and without using a special binding agent material, which eliminates the need for cost-intensive consumables.

FIGS. 19 through 24 show dust separation containers where the separation of dust occurs according to the principle of inertia. The dust separation container shown in FIG. 19 and denoted by reference numeral 201 is essentially formed by three parts: a collection container 202, a cover 203, and a partition 204 disposed therebetween. All three parts are joined together as a push-fit system, and can be separated for cleaning.

Collection container 202 is formed by a rigid-walled, air-tight plastic part, and its contours are adapted to the dust collection chamber of a canister vacuum cleaner (not shown in the drawing). It can be angular or round in cross-section. Collection container 202 is closed upwardly by partition 204. Partition 204 is provided with a first opening 205 which is surrounded by a collar 206 extending around opening 205 on the side opposite the collection container 202. In addition, a second opening 207 is provided in which is inserted a coarse dust filter 208. Cover 203 is placed on partition 204, the upper covering surface 209 of said cover being oriented at least nearly parallel to partition 204. Cover 203 is provided with an opening 210 which constitutes the air inlet and is surrounded by an air intake collar 221 for this purpose. The air outlet is formed by outlet openings 212 which are provided in cover 203 (see FIG. 20), which should have as large an area as possible, and which are arranged around air inlet opening 210 and covered by an inner fine dust filter 213. To this end, cover 203 is provided with a suitable lattice structure 214, which is shown in FIG. 20. To obtain as large an effective area as possible, both the outlet openings 212 and fine dust filter 213 extend in upper covering surface 209 and in the side walls 215 adjacent of cover 203 adjacent to the upper covering surface.

Air inlet opening 210 and first opening 205 in partition 24 are located coaxially behind each other, and thus, collar 206 forms a surrounding, frustoconical gap 216 whose area is approximately equal to the cross-sectional area of air inlet opening 210. Because the air outlet is arranged around air inlet opening 210, the dust-laden air drawn in is caused to undergo an abrupt change in direction, which is symbolized by arrows 217 in FIG. 19. Due to their inertia, large, i.e., relatively heavy dust particles 218 are unable to follow this change in direction, but maintain their direction of flow and fall into collection container 202. The air, which is freed of coarse dust and is only laden with fine dust at this point of time, is then passed through fine dust filter 213 (see arrows 219), where the fine dust is removed therefrom. In this manner, the movement of air in collection container 202 is minimized, and dirt 220, once it has settled, is not stirred up, unlike in known tank vacuum cleaners, in which the vacuuming air flow is entirely passed through the collection chamber. In the region of the sharp change in direction, turbulences and swirls are inevitably generated and, in a weaker form, may propagate into the collection container. Due to the highly symmetrical design of annular gap 216, these effects are significantly reduced, and a further reduction is obtained by diverting the flow through second opening 207 in partition 204, which acts as a bypass. The filter 208 provided in the opening prevents fine dust filter 213 from being loaded with coarse dust, and must be dimensioned such that it can retain the coarse dust in collection container 202.

In order to facilitate the advantages of the present invention, it is advantageous to use the following design principles:
1. The area of annular gap 216 is approximately equal to the cross-sectional area of air inlet opening 210. Changing the cross-sectional area would result in an acceleration or a reduction of the air velocity, which would increase the turbulences in the deflection region.
2. The diameter of opening 205 is 10-20% larger than the diameter of air inlet opening 210. This ensures that all coarse dust particles 218 are reliably collected by collection container 202.
3. The height of collar 206 is preferably between 10 and 30 mm. If the distance is too short, disturbances propagate from the deflection region into collection container 202, and produce increased air velocities therein. If the distance is too large, the coarser dust particles 218 no longer reliably reach collection container 202.

The aforementioned design features are targeted to provide a cut size of about 30 μm, which means that only coarser dust 218 will be collected in collection container 202. Thus, stirring up of dust, which is known from conventional cyclone separators, is prevented during emptying of container 202. However, after the separation is effected by deflecting the air, the air still contains an amount of dust so large that conventional blow-out filters disposed downstream of the fan (not shown) would be completely overloaded unless additional measures were taken.

In accordance with the present invention, this problem is solved by adding the fine dust filter 213 downstream. Advantageously, this filter is designed such that, in conjunction with the dust separation at annular gap 216, it reaches the filter performance of a conventional dust bag. Filter 213 may be designed as a depth or volume filter, or as a surface filter and, more specifically, as a recoverable permanent filter or as a replaceable, disposable filter.

FIGS. 21 and 22 show two further advantageous embodiments of the present invention. Like or functionally equivalent components are denoted by the same reference numerals as in FIG. 19.

The dust separation container 201 shown in FIG. 21 is compact in design, but its fine dust filter 213 is significantly larger than in the first embodiment, because here, in addition to upper covering surface 209, side surfaces 221 are also designed as a filter. In this manner, the collection capacity, and thus the service life of fine dust filter 213, is significantly increased, so that replacement or back-cleaning is required only very rarely (about once a year). Rigid-walled collection container 202 can be easily emptied if its bottom 222 is removable.

Although the major part of the fine dust is bound within filter 213, a small part will soil the surface of fine dust filter 213 and the opposite outer surface of collection container 202. Therefore, in the two embodiments illustrated hereinabove, there is risk of the user coming into contact with the fine dust when removing fine dust filter 213 for purposes of cleaning or replacement.

This disadvantage is obviated by a dust separation container 201 designed as illustrated in FIG. 22. There, fine dust filter 213 is designed as an internally loaded hollow member 223 which is structurally separate from collection container 202 and which, via an opening 225 having an attachment collar 226 formed thereon, is in communication with chamber 224 extending between partition 204 and upper covering surface 209 (which has no filtering function here). Thus, the user can easily replace filter 213 without coming into contact with fine dust.

The above-described dust separators allow dust to be separated into two fractions: coarse and fine dust. If the intention is to prevent dust from being stirred up during emptying of dust separation container 201, a dust-binding agent can be added to container 201 as described above. Since the coarse dust constitutes about 90% of the total mass of dust, the consumption of dust-binding agent is very high. FIGS. 23 and 24 therefore disclose a dust separation container 300 that allows dust to be separated into a total of three fractions; i.e., the coarse dust is separated into a coarse fraction and a medium fraction (see also FIG. 16). The air laden with dirt 306, 307 enters, via a port 301, into a first collection container 302, in which the coarsest dirt fraction 306 is separated by gravity because of the reduced flow velocity. Smaller and lighter particles beyond 200 μm are passed on to annular gap separator 303 in spite of the reduced air velocity. There, a medium dust fraction 307 is separated and collected in a second collection container 304. The third and finest dust fraction (<30 μm) is carried by the air flow into the internally loaded fine dust filter 305 where it is separated.

This has the following advantage during emptying of the containers: The first fraction, which contains only coarse particles, can be emptied without stirring up any dust and without using a binding agent. Therefore, binding agent is needed only for the middle fraction. The amount required for binding can therefore be significantly reduced compared to methods where the first two fractions are collected in one container.

Another advantage is the greater freedom in the selection and constructional embodiment of the method for separating fine dust. This is because if only two fractions are produced, all flow paths must be designed such that they are suitable for the largest occurring particles. These are limited to about 30 mm by the inside diameter of the accessories. Since in the proposed method, these large particles are already retained in first collection container 302, a number of new options are available for separating fine dust:

Instead of an annular gap separator 303 having an inlet diameter of at least 30 mm, it is possible to use two or more smaller annular gap separators 303a and 303b connected in parallel, as shown in FIG. 24. For the same performance, a plurality of smaller separators offer less resistance to flow than a large one and are easier to incorporate into an available space.

Fine dust filter 400, various embodiments of which are shown in FIGS. 25 through 29, is connected downstream of the above-described dust separation systems. Regardless of whether the system is designed as a cyclone separator (FIGS. 1 through 15) or whether it operates according to the principle of inertia/as an annular gap separator (FIGS. 19 through 24), fine dust filter 400 has the function of binding the particles that have passed through the pre-separator so as to prevent them from being returned into the ambient air. In accordance with the present invention, the dust separation system is designed to have a larger cut size than conventional systems and, therefore, only collects dust up to about 30 μm. Dust that is smaller than 30 μm (hereinafter be referred to as “fine dust”) for the most part enters fine dust filter 400.

FIGS. 25 and 26 illustrate the basic design of the proposed filter system, which is preferably configured as a rectangular cartridge. Front and rear filter media 402 and 403 are contained in a frame-like or rectangular holding member 401 which is open on the broad and both sides. Furthermore, air inlet 404 for the exhaust air from the dust separation system is provided in the upper side of holding member 401. Holding member 401 is preferably in the form of a rectangular folding frame. In another, alternative design, it is proposed to configure holding member 401 as a circumferentially closed, air-permeable, porous hollow member which also has filtering properties and in which filter media 402 and/or 403 are inserted, it being possible for filtering holding member 401 and internal filter media 402 and/or 403 to have different filtering properties. For example, holding member 401 may preferably be made of sintered plastic or a comparable material. This multi-stage filter system makes it possible to achieve the performance of very fine filters. The dimensions of the cartridge-like filter geometry are adapted to the spatial conditions of a commercial canister vacuum cleaner and should be in the range of a standard pack of vacuum filter bags, H×W×D about 170 mm×230 mm×85 mm.

FIG. 27 and FIG. 28 are detailed views of one embodiment of the first design alternative, while FIG. 29 shows another embodiment of this alternative.

FIG. 27 is a top view showing fine dust filter 400 along with filter media 402 and 403 and air inlet 404. In this variant, filter medium 402, 403 is made of a highly retentive, mat-like filter fleece which is preferably electrostatically charged and may be natural or synthetically produced, the mat having a thickness of about 10 to 20 mm. Electrostatic charging is effected during manufacture of the filter fleece. Air inlet 404 is preferably configured as an elongated slot to ensure optimum flow onto filter medium 402, 403. FIG. 27 further shows the filter-material free hollow space 405 which is located between filter medium 402, 403 and air inlet 404 and which also promotes an optimum flow onto filter medium 402, 403.

FIG. 28 also shows the filter-material free hollow space 405 located between filter medium 402, 403 and air inlet 404. Moreover, the exhaust air flow from the dust separation system is symbolized by arrows 406. The filter system can be further improved by providing absorbent cotton or absorbent-cotton like material in hollow space 405 between the two filter media 402, 403. Tests have shown that especially smaller particles <15 μm can be effectively bound or retained in absorbent cotton.

FIG. 29 is a top view illustrating another variant. Here, filter medium 402, 403 is made of a highly retentive, thin filter fleece which is preferably electrostatically charged and may be natural or synthetically produced, the fleece layer having a thickness of about 4 to 7 mm. In order to achieve a comparable dust collection capacity while keeping the flow losses low, the filter fleece 402, 403 of this embodiment must be folded or pleated. “Pleating angle” α is about 30°. The pleating provides a large filtering area. When using the above-described filter mat, the capacity is mainly provided by a high level of depth retention.

1-66. (canceled)

67. A method for treating dust, the method comprising:
separating, in a vacuum cleaner, the dust into at least two fractions which differ in at least one of a size and a mass of particles of the dust; and
adding a dust-binding agent to at least a first of the fractions.

68. The method for treating dust as recited in claim 67, further comprising collecting, in a fine dust filter, a second fraction of the fractions, the second fraction having a majority of dust particles smaller than dust particles of the first fraction.

69. The method for treating dust as recited in claim 67, wherein the at least two fractions include three fractions and wherein the first fraction includes dust particles having a majority of medium size or mass.

70. The method for treating dust as recited in claim 69, wherein the three fractions include second and third fractions and wherein the second fraction includes a majority of dust particles having a size larger than 200 μm, the first fraction includes a majority of dust particles having a size of between 200 μm and 30 μm, and the third fraction includes a majority of dust particles having a size of less than 30 μm.

71. The method for treating dust as recited in claim 67, wherein the dust-binding agent is added into a dust collection container which is insertable into the vacuum cleaner and removable from the vacuum cleaner.

72. The method for treating dust as recited in claim 71, wherein at least one of a quantity of addition, a time of addition and a frequency of addition, of the dust-binding agent, is controllable as a function of at least one of time, filling level and dust quantity.

73. The method for treating dust as recited in claim 71, wherein the dust-binding agent is added into at least one of a suction air stream upstream of the dust collection container and directly into the dust collection container inserted in the vacuum cleaner including a fan, the fan being ON.

74. The method for treating dust as recited in claim 71, wherein the dust-binding agent is added into the dust collection container automatically after the dust collection container is inserted into a dust collection chamber of the vacuum cleaner.

75. The method for treating dust as recited in claim 67, wherein the dust-binding agent includes a single- or multi-component additive which is present in at least one of a solid, liquid and gaseous phase, the at least one solid, liquid and gaseous phase changable so as to at least one of bind and mix at least one of loose and unbound dust that has been drawn in, and to thereby, at least partially, bind the dust.

76. The method for treating dust as recited in claim 75, wherein the at least one phase of the dust-binding agent is changeable by at least one of supplying and removing energy, including heat energy or kinetic energy.

77. The method for treating dust as recited in claim 75, wherein the dust-binding agent includes at least one of a liquid, a powder, a foam, a granular material and a solid substance.

78. The method for treating dust as recited in claim 77, wherein the liquid is dispersible.

79. The method for treating dust as recited in claim 77, wherein the solid substance is in pelletized form.

80. The method for treating dust as recited in claim 67, further comprising adding at least one of a scent and an anti-germ substance to the dust-binding agent.

81. The method for treating dust as recited in claim 77, wherein the dust-binding agent includes the granular material, the granular material supplemented with an agent that enhances its adhesive properties for dust.

82. The method for treating dust as recited in claim 67, further comprising providing a sponge-like object so as to bind the dust.

83. The method for treating dust as recited in claim 82, wherein the sponge-like object is located on a bottom of a dust collection container of the vacuum cleaner.

84. The method for treating dust as recited in claim 83, wherein the dust-binding agent is a liquid and wherein the sponge-like object is impregnated with the liquid dust-binding agent, the dust-binding agent having a low vapor pressure.

85. The method for treating dust as recited in claim 83, wherein the liquid dust-binding agent includes at least one of glycerol and glycol.

86. The method for treating dust as recited in claim 85, wherein a coating which is permeable to liquid and has a high capillarity is provided on the sponge-like object on a side of the sponge-like object facing a dust inlet of the collection container.

87. The method for treating dust as recited in claim 86, wherein the coating includes Cellulose fibers.

88. The method for treating dust as recited in claim 67, further comprising generating an electromagnetic field so as to bind the dust.

89. The method for treating dust as recited in claim 67, wherein the dust-binding agent includes water.

90. A device for treating dust picked up by a vacuum cleaner, comprising:
a dust separating arrangement configured to separate the dust into at least two fractions which differ in a size of particles of the dust;
a dust-binding arrangement configured to add a dust-binding agent to a first fraction of the fractions in a dust collection container of the vacuum cleaner; and
a fine dust filter configured to collect a second fraction of the at least two fractions, the second fraction having a majority of dust particles smaller than dust particles of the first fraction.

91. The device for treating dust as recited in claim 90, further comprising an air inlet and an air outlet, and wherein the collection container is a rigid-walled collection container, and wherein the air inlet and the air outlet are separated from the collection container by a partition having an opening, and wherein the air inlet, air outlet, the partition and the opening thereof are disposed so as to cause an abrupt change in direction of the air flow such that particles of the dust of a predetermined minimum size are separated from the air flow by inertia, and are retained in the collection container below the partition.

92. The device for treating dust as recited in claim 91, wherein the air inlet is formed as an opening in a covering surface of the container and the partition, in a region of the opening thereof, is disposed approximately parallel to the covering surface.

93. The device for treating dust as recited in claim 92, wherein the opening of the partition is surrounded by a collar directed toward an opening of the air inlet.

94. The device for treating dust as recited in claim 93, wherein the openings of the partition and the air inlet are circular in shape and form a cylindrical or frustoconical gap.

95. The device for treating dust as recited in claim 94, wherein the openings are disposed in coaxial relationship.

96. The device for treating dust as recited in claim 94, wherein a width of the gap is such that the cylindrical or frustoconical lateral area formed by the gap is approximately equal to the cross-sectional area of the opening of the air inlet.

97. The device for treating dust as recited in claim 91, wherein the partition includes a bypass opening.

98. The device for treating dust as recited in claim 91, wherein the collection container is removable from the remainder of the device.

99. The device for treating dust as recited in claim 91, further comprising a cover including the air inlet, openings for air outlet, and the fine dust filter.

100. The device for treating dust as recited in claim 99, wherein the outlet openings and the fine dust filter extend in an upper covering surface and in side walls adjacent thereto.

101. The device for treating dust as recited in claim 91, wherein the fine dust filter is configured as a hollow member that is structurally separate from the collection container.

102. The device for treating dust as recited in claim 91, wherein the dust separating arrangement includes a container adapted to inner contours of the dust collection chamber.

103. The device for treating dust as recited in claim 102, wherein the vacuum cleaner is a canister vacuum cleaner.

104. The device for treating dust as recited in claim 90, further comprising a second dust collection container fluidically arranged in series with the dust collection container for collecting fractions of dust particles of different sizes or masses.

105. The device for treating dust as recited in claim 104, wherein the containers are configured such that a cut size of the first container is about 200 μm and a cut size of the second container is about 30 μm.

106. The device for treating dust as recited in claim 90, wherein the device is constructed as an external device separate from the vacuum cleaner.

107. The device for treating dust as recited in claim 90, wherein the device is disposed within a vacuum cleaner.

108. The device for treating dust as recited in claim 90, wherein the device is disposed within a vacuum attachment for a vacuum cleaner.

109. The device for treating dust as recited in claim 106, further comprising an actuating arrangement configured to activate the dust-binding arrangement.

110. The device for treating dust as recited in claim 108, wherein the vacuum cleaner or the vacuum attachment includes a controller configured to automatically activate the dust-binding arrangement at least one of prior to the beginning of a vacuuming process, at the beginning of the vacuuming process, during the vacuuming process and after completion of the vacuuming process.

111. The device for treating dust as recited in claim 110, further comprising a sensor configured to detect a filling level of the collection container based on at least one of a pressure, a filling-level, and a dust-quantity.

112. The device for treating dust as recited in claim 110, wherein the dust-binding arrangement includes a dispensing device actuatable by the controller.

113. The device for treating dust as recited in claim 112, wherein the dispensing device includes a dispensing pump configured to dispense at least one of liquid, foamy, powdery or granular media.

114. The device for treating dust as recited in claim 113, wherein the dispensing device includes a nozzle configured to distribute the dust-binding agent, the nozzle being located downstream of the dispensing pump.

115. The device for treating dust as recited in claim 114, wherein the dispensing arrangement includes a valve actuatable by the controller.

116. The device for treating dust as recited in claim 115, wherein the dispensing device includes at least one of an emptiable magazine, a dispensing flap, a dispensing screw, and a dispensing piston for solid, powdery or granular media.

117. The device for treating dust as recited in claim 106, further comprising a pressing device configured to press the first fraction into the dust-binding agent.

118. The device for treating dust as recited in claim 106, further comprising a mixing device configured to mix the first fraction and the dust-binding agent.

119. The device for treating dust as recited in claim 118, wherein the mixing device includes an agitator.

120. The device for treating dust as recited in claim 106, further comprising a heating device configured to act on the dust collection container.

121. The device for treating dust as recited in claim 120, further comprising a cooling device configured to act on the dust collection container.

122. The device for treating dust as recited in claim 121, wherein at least one of the heating device and the cooling device is disposed in the dust collection container.

123. The device for treating dust as recited in claim 121, wherein at least one of the heating device and the cooling device is disposed in the vacuum cleaner.

124. The device for treating dust as recited in claim 121, wherein at least one of the heating device and the cooling device is disposed in a holding device for the dust collection container, the holding device being spatially separated from the vacuum cleaner.

125. The device for treating dust as recited in claim 106, wherein at least portions of the collection container includes a non-stick coating disposed thereon.

126. The device for treating dust as recited in claim 106, wherein at least portions of the collection container are elastic.

127. The device for treating dust as recited in claim 90, wherein the device has a fine dust collection capacity of at least 200 grams.

128. The device for treating dust as recited in claim 127, wherein the fine dust filter includes a cartridge filter configured to receive a fleece mat as the filter material.

129. The device for treating dust as recited in claim 128, wherein the cartridge filter has a rectangular shape and includes a central air inlet in a covering surface of the cartridge filter and an air outlet in two opposite side walls of the cartridge filter.

130. The device for treating dust as recited in claim 129, wherein the filter mat and a second fleece mat are respectively disposed in the side walls.

131. The device for treating dust as recited in claim 130, wherein the cartridge filter includes a collection space free of fleece and disposed between the fleece mats.

132. The device for treating dust as recited in claim 131, wherein the collection space has absorbent cotton disposed thereon.

133. The device for treating dust as recited in claim 128, wherein the fleece mat is pleated.

134. The device for treating dust as recited in claim 133, wherein a pleating angle α of the fleece mat is about 30°.

135. The device for treating dust as recited in claim 128, wherein the fleece mat is electrostatically charged.

136. The device for treating dust as recited in claim 128, wherein the fleece mat includes a synthetic material.

137. The device for treating dust as recited in claim 128, wherein the fleece mat includes a natural fiber.
